(19) United States
(12) Patent Application Publication
(10) Pub. No.: US 2015/0055162 A1
(43) Pub. Date: Feb. 26, 2015

(54) IMAGE FORMING APPARATUS, INFORMATION PROCESSING APPARATUS, SYSTEM, INFORMATION PROCESSING METHOD, AND STORAGE MEDIUM

(71) Applicant: CANON KABUSHIKI KAISHA, Tokyo (JP)

(72) Inventor: Junko Nakajima, Yokohama-shi (JP)

(21) Appl. No.: 14/465,704

(22) Filed: Aug. 21, 2014

(30) Foreign Application Priority Data
Aug. 26, 2013 (JP) 2013-174826

(51) Int. Cl. G06F 21/60

(52) U.S. Cl. CPC G06F 21/608
USPC 358/1.13

(57) ABSTRACT

An image forming apparatus includes a receiver configured to receive data which owner information is attached to, the owner information indicating an owner of the data, a storage device configured to store the data, an input device configured to receive an input of a print instruction from a login user, and a print control unit configured to execute a print process of the data in accordance with the print instruction, wherein the print control unit is configured to determine whether to use authority of the login user or the owner of the data in a case where the login user does not correspond to the owner of the data.

### BACKGROUND OF THE INVENTION

1. Field of the Invention

The present invention relates to an image forming apparatus, an information processing apparatus, a system, an information processing method, and a storage medium.

2. Description of the Related Art

When print data (a print job) is received from a terminal apparatus, such as a personal computer, a conventional multifunction peripheral has immediately performed print output. In this case, information leakage may occur because of failure to pick up a print product or because a neglected print product is exposed to the eye of any third person. Japanese Patent Application Laid-Open No. 2007-251279 discusses reservation printing in which a multifunction peripheral does not immediately start printing upon reception of print data but starts performing print output when a print instruction request is received from a user via an operation unit, thus preventing a print product from being neglected.

Further, a printing system is discussed in which only print data entered by a user currently operating (logging in) is displayed out of reserved print data, and a print instruction request is permitted, thus preventing a print product from being output by users other than the user who entered print data. Further, Japanese Patent Application Laid-Open No. 2006-260023 discusses a reservation printing system in which a terminal apparatus supplies print permission user information to print data at the time of print data transmission, the print data is displayed to a user included in the print permission user information, and a print instruction request is permitted.

In the above-described reservation printing systems, a user who entered print data (supplier) may differ from a user who issues a print instruction request (instructor).

### SUMMARY OF THE INVENTION

The present invention is directed to providing a technique for controlling printing by using suitable user information in a case where a user who entered print data (supplier) differs from a user who issues a print instruction request (instructor).

According to an aspect of the present invention, an image forming apparatus includes a receiver configured to receive data which owner information is attached to, the owner information indicating an owner of the data, a storage device configured to store the data, an input device configured to receive an input of a print instruction from a login user, and a print control unit configured to execute a print process of the data in accordance with the print instruction, wherein the print control unit is configured to determine whether to use authority of the login user or the owner of the data in a case where the login user does not correspond to the owner of the data.

According to the present invention, it is possible to provide a technique for controlling printing based on suitable user information.

Further features of the present invention will become apparent from the following description of exemplary embodiments with reference to the attached drawings.

### BRIEF DESCRIPTION OF THE DRAWINGS

FIG. 1 illustrates an example printing system configuration.

FIG. 2 illustrates an example hardware configuration of a personal computer (PC).

FIG. 3 illustrates an example hardware configuration of a multifunction peripheral.

FIG. 4 illustrates an example software configuration of the multifunction peripheral.

FIG. 5 illustrates an example job management table.

FIG. 6 is a flowchart (1) illustrating example processing performed by the PC.

FIG. 7 illustrates an example print setting screen.

FIG. 8 illustrates an example print permission information setting screen.

FIG. 9 illustrates an example print permission user setting screen.

FIG. 10 is a flowchart (1) illustrating example processing performed by the multifunction peripheral.

FIG. 11 is a flowchart (2) illustrating example processing performed by the multifunction peripheral.

FIG. 12 illustrates an example print data list.

FIG. 13 is a flowchart (3) illustrating example processing performed by the multifunction peripheral.

FIG. 14 is a flowchart (4) illustrating example processing performed by the multifunction peripheral.

FIG. 15 is a flowchart (5) illustrating example processing performed by the multifunction peripheral.

FIG. 16 is a flowchart (6) illustrating example processing performed by the multifunction peripheral.

FIG. 17 illustrates example substitutional printing determination information.

FIG. 18 is a flowchart (7) illustrating example processing performed by the multifunction peripheral.

FIG. 19 illustrates example specific print job name information.

FIG. 20 is a flowchart (8) illustrating example processing performed by the multifunction peripheral.

FIG. 21 illustrates an example job control information setting screen of the multifunction peripheral.

FIG. 22 is a flowchart (2) illustrating example processing performed by the PC.

FIG. 23 illustrates an example job control information setting screen of the PC.

FIG. 24 is a flowchart (9) illustrating example processing performed by the multifunction peripheral.

FIG. 25 is a flowchart (10) illustrating example processing performed by the multifunction peripheral.

FIG. 26 is a flowchart (11) illustrating example processing performed by the multifunction peripheral.

### DESCRIPTION OF THE EMBODIMENTS

Various exemplary embodiments, features, and aspects of the invention will be described in detail below with reference to the drawings.

Exemplary embodiments of the present invention will be described below with reference to the accompanying drawings.

### (System Configuration)

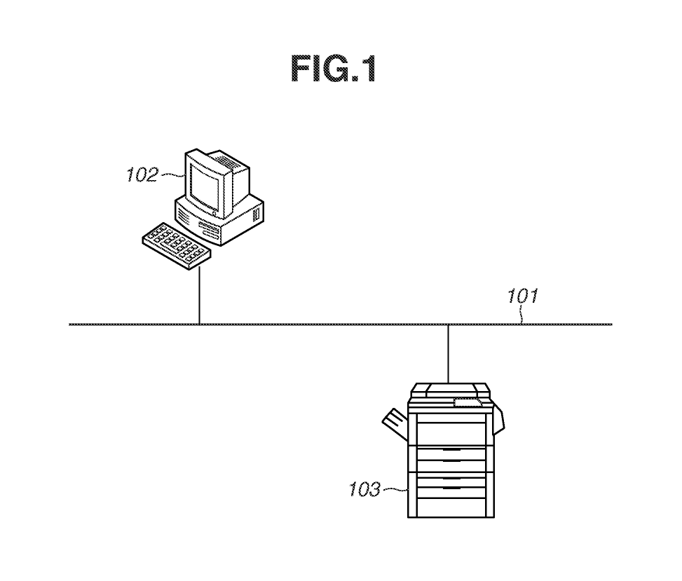

FIG. 1 illustrates an example printing system configuration of a printing system (reservation printing system) according to a first exemplary embodiment.

A network 101 supports, for example, the TCP/IP protocol. A personal computer 102 (hereinafter referred to as a PC 102) and a multifunction peripheral 103 are connected to the network 101. The PC 102 is an example information processing apparatus. The multifunction peripheral 103 is an example image forming apparatus. In the system illustrated in FIG. 1, any number of the PCs 102 and any number of the multifunction peripherals 103 can be connected to the network 101.

Upon reception of print data (a print job) from the PC 102, the multifunction peripheral 103 can perform print output or store the print data to perform print output afterwards. As described above, reservation printing refers to a printing method in which the multifunction peripheral 103 stores the print data received from the PC 102, and, upon reception of a user print instruction via an operation unit, performs print output.

The multifunction peripheral 103 in the printing system according to the present exemplary embodiment determines whether the print job entered via the PC 102 is to be controlled based on the authority information of a supplier who entered the print job or based on the authority information of an instructor who gave an instruction to perform printing via the operation unit. Then, the multifunction peripheral 103 controls the print job by using the authority information according to the result of the determination. The authority information refers to information about the print right, such as print settings permitted on a user or group basis. Print job control includes print job execution, and counter update and log registration (recorded information) accompanying print job execution.

### (Hardware Configuration of PC 102)

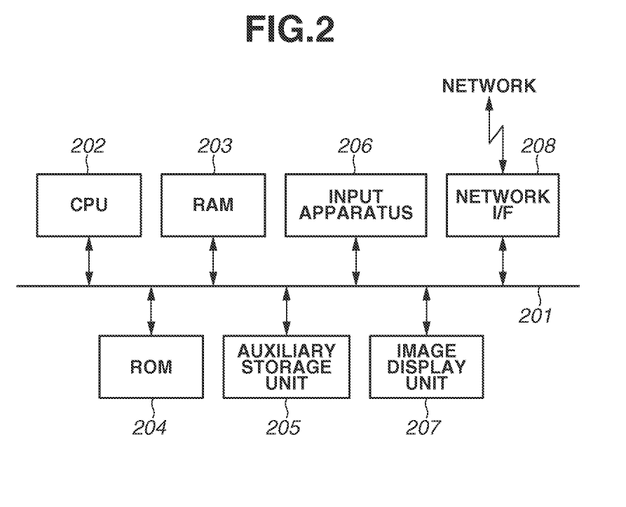

FIG. 2 illustrates an example hardware configuration of the PC 102.

The central processing unit (CPU) 202 controls the entire PC 102. When the CPU 202 executes programs stored in a read only memory (ROM) 204, the function of the PC 102 and the processing of the flowcharts related to the PC 102 (described below) are implemented.

A random access memory (RAM) 203 provides a work area for the CPU 202.

The ROM 204 stores various programs and various data to be used for processing executed by the CPU 202.

An auxiliary storage unit 205 is a hard disk which provides control programs according to the present exemplary embodiment.

An image display unit 207 is a cathode ray tube (CRT) display, a liquid crystal display (LCD) for presenting a message to a user.

An input apparatus 206 is a mouse or a keyboard which allows the user to input information to the PC 102.

A network interface (I/F) 208 can mutually exchange data with other networking apparatuses via a network.

A bus 201 is a main bus for connecting the above-described apparatuses.

### (Hardware Configuration of Multifunction Peripheral 103)

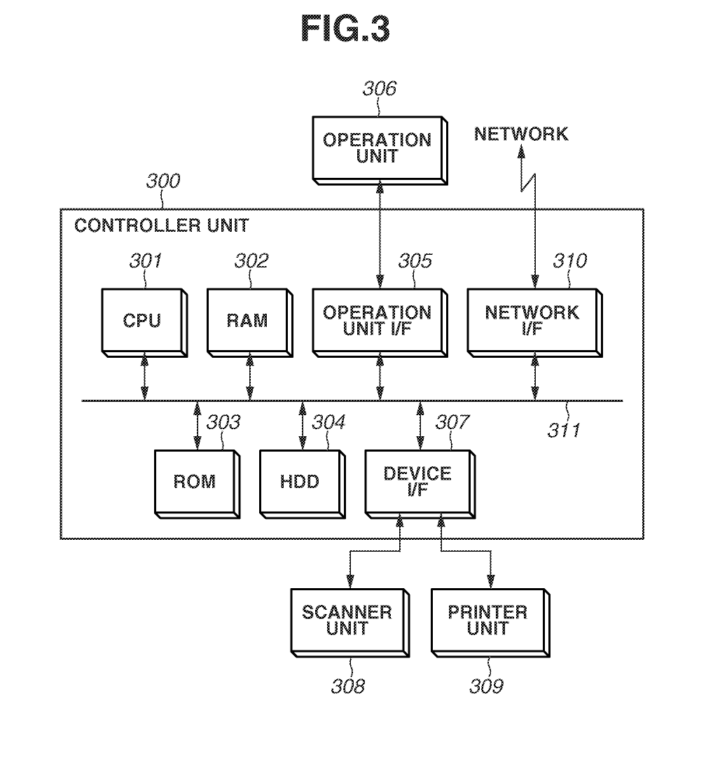

FIG. 3 illustrates an example hardware configuration of the multifunction peripheral 103.

A controller unit 300 controls the multifunction peripheral 103.

A CPU 301, a RAM 302, a ROM 303, a hard disk drive (HDD) 304, an operation unit I/F 305, a device I/F 307, and a network I/F 310 are connected to a system bus 311.

The CPU 301 totally controls each apparatus connected to the system bus 311. When the CPU 301 executes programs stored in the ROM 303, the function (software configuration) of the multifunction peripheral 103, the function of an operating system (OS), and the processing of the flowcharts related to the multifunction peripheral 103 are implemented.

The RAM 302 stores various programs to be loaded by the CPU 301. Various programs include programs of the OS (hereinafter referred to as OS programs), programs of system software (hereinafter referred to as system programs), and programs of application software (hereinafter referred to as application programs). The RAM 302 further temporarily stores various data.

The ROM 303 stores the boot program of the system. The ROM 303 further stores system programs and application programs. The ROM 303 may further store font-related data required for image formation.

The HDD 304 is a storage area for storing various setting data, such as OS programs, system programs, application programs, image data, and various setting data including data related to threshold values. The multifunction peripheral 103 may not be provided with the HDD 304. In this case, the multifunction peripheral 103 stores in the ROM 303 the data to be stored in the HDD 304. Further, instead of the HDD 304, the multifunction peripheral 103 may be provided with storage devices other than a hard disk. Specifically, the multifunction peripheral 103 may be provided with flash memories, such as a solid state disk (SSD).

An operation unit I/F 305 serves as an interface unit with an operation unit 306 having a touch panel. The operation unit I/F 305 outputs to the operation unit 306 image data to be displayed on the operation unit 306. Further, the operation unit I/F 305 transmits to the CPU 301 information input by the user via the operation unit 306.

A device I/F 307 connects a scanner unit 308 and a printer unit 309 (image input and output devices) with the controller unit 300 to perform image data input and output operations. Image data input from the scanner unit 308 via the device I/F 307 is stored in the RAM 302 and the HDD 304. If necessary, applications of the multifunction peripheral 103 perform image processing on stored image data. The CPU 301 outputs image data to the printer unit 309 via the device I/F 307. The multifunction peripheral 103 may not be provided with the scanner unit 308, as with the case with a printer.

The network I/F 310 connects with a network, and inputs and outputs image data and information for controlling the multifunction peripheral 103 from/to external apparatuses on the network.

The hardware configuration of the multifunction peripheral 103 is not limited to the configuration illustrated in FIG. 3. For example, when the multifunction peripheral 103 is provided with a FAX function, the controller unit 300 may include a modem unit I/F, and connect with a public line via a modem to perform FAX transmission. Further, the controller unit 300 may include a universal serial bus (USB) I/F to enable the multifunction peripheral 103 to read and print data stored in a flash memory card.

### (Software Configuration of Multifunction Peripheral 103)

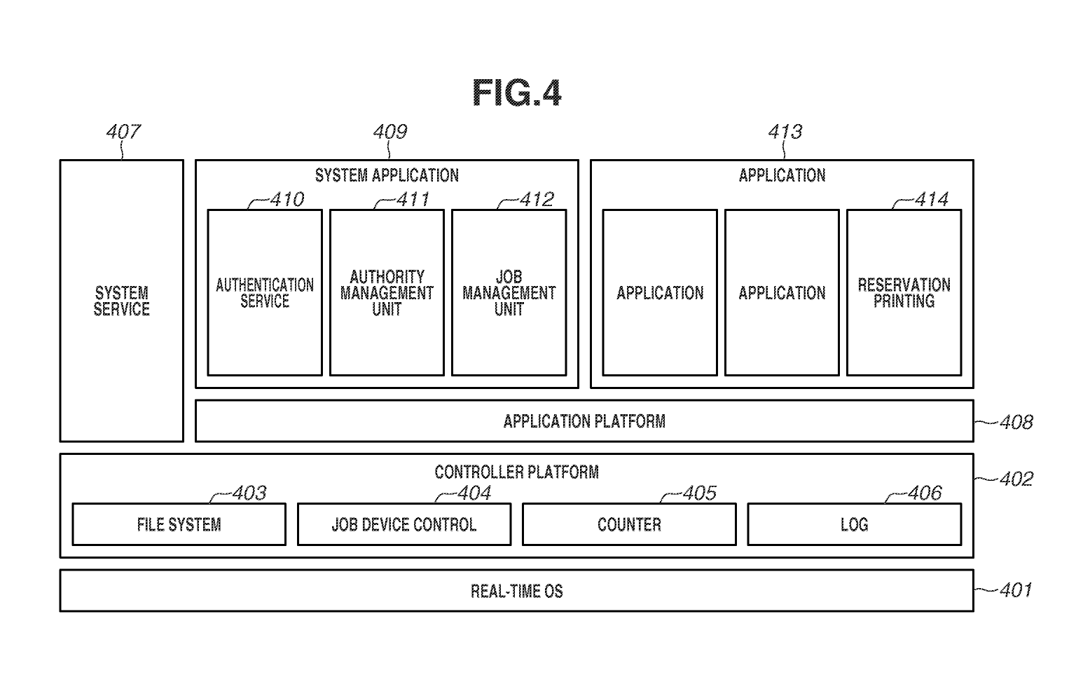

FIG. 4 illustrates an example software configuration of the multifunction peripheral 103.

The software configuration illustrated in FIG. 4 is implemented in the controller unit 300. Software implemented in the controller unit 300 is installed as firmware, and is realized by the CPU 301.

A real-time OS 401 provides software operating on the real-time OS 401 with various resource management services and frameworks optimized for embedded system control. Various resource management services and frameworks provided by the real-time OS 401 include multitasking management for substantially executing a plurality of pieces of processing in parallel by managing a plurality of processing execution contexts by the CPU 301, and inter-task communication for achieving synchronization and data exchange between tasks. The above-described various resource management services and frameworks further include memory management, interruption management, various device drivers, and protocol stacks for implementing processing of various protocols, such as local interfaces, networks, and communications.

A controller platform 402 includes a file system 403, a job device control 404, a counter 405, and a log 406.

The file system 403 stores data configured on storage devices, such as the HDD 304 and the RAM 302. The file system 403 performs job spooling for jobs handled by the controller unit 300, and stores various data.

The job device control 404 controls the hardware of the multifunction peripheral 103, and controls jobs using basic functions (printing, scanning, communication, image conversion, etc.) provided by the hardware.

The counter 405 manages the validity term for each application, and printing and scanning counter information. The counter 405 manages printing and scanning counter information on a user and a group (section) basis. The above-described counter information may be used for upper-limit management and charging processing.

The log 406 records and manages a job execution history and an operation history of data stored in the file system 403, together with user information about users who executed jobs and group information about groups to which users belong to.

The system service 407 is a module for monitoring the operation status of the multifunction peripheral 103, and downloading programs and license of software from a software distribution server via a network.

The application platform 408 is middleware for enabling system applications 409 and appendable applications 413 (described below) to utilize the mechanisms of the real-time OS 401 and the controller platform 402.

The system applications 409 include an authentication service 410, an authority management unit 411, and a job management unit 412.

The authentication service 410 checks in a user database stored in the HDD 304 a user name and a password input via the operation unit 306 or the network to perform user authentication. The authentication service 410 does not necessarily need to perform user authentication in the user database stored in the HDD 304. For example, an external authentication server, such as ActiveDirectory, may perform the authentication.

The authority management unit 411 is a security module for enabling and disabling access to jobs and various resources based on the user authority and security settings set in data.

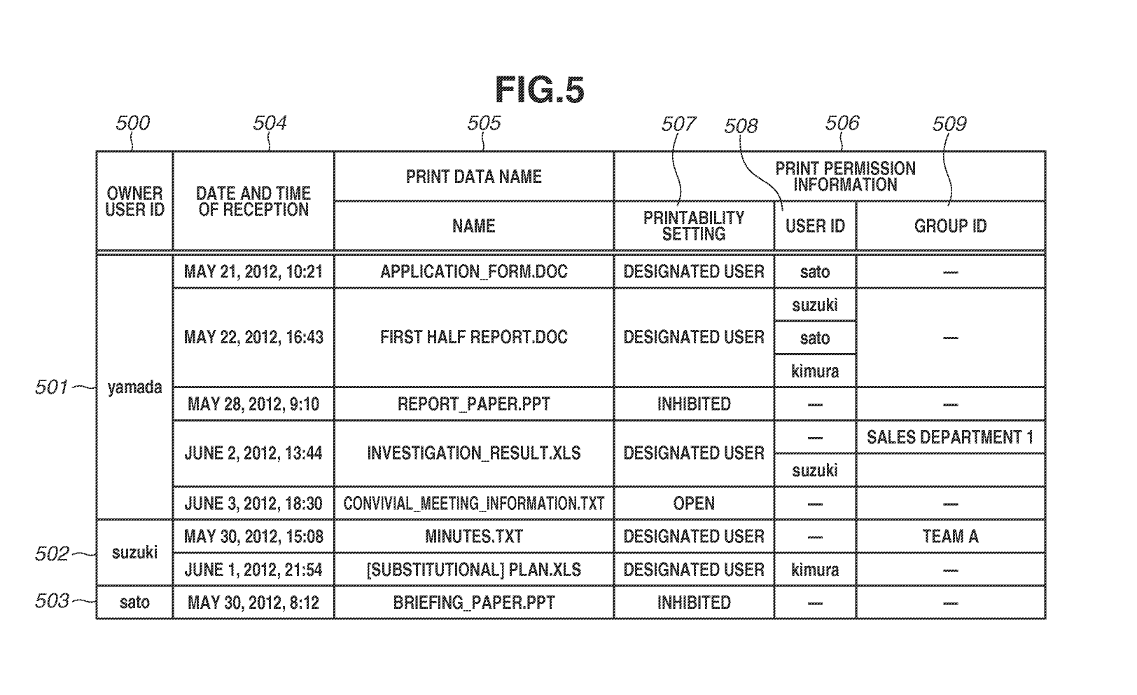

The job management unit 412 is a module for managing print data entered in the multifunction peripheral 103 via the network, and stored in the HDD 304, on an owner basis. The job management unit 412 stores a job management table 500 illustrated in FIG. 5 in the HDD 304. FIG. 5 illustrates an example job management table 500.

Bibliographic information 501, bibliographic information 502, and bibliographic information 503 are lists of bibliographic information about print data of owners “yamada”, “suzuki”, and “sato”, respectively. The bibliographic information includes the date and time of reception of print data 504, a print data name 505, and print permission information 506. The print permission information 506 includes a printability setting 507, a print permission user ID 508, and a print permission group identifier (ID) 509. The print permission information 506 further indicates a printing execution permission target based on a designated user setting.

Each application 413 is a module for displaying a menu on the operation unit 306 and receiving an input from the user to provide the user with various functions achieved by the multifunction peripheral 103.

A reservation print application 414 (hereinafter simply referred to as an application 414), one of applications 413, displays reservation print data in list form, performs reservation determination upon reception of print data, and performs print output processing.

### (Print Data Transmission Procedure by PC 102)

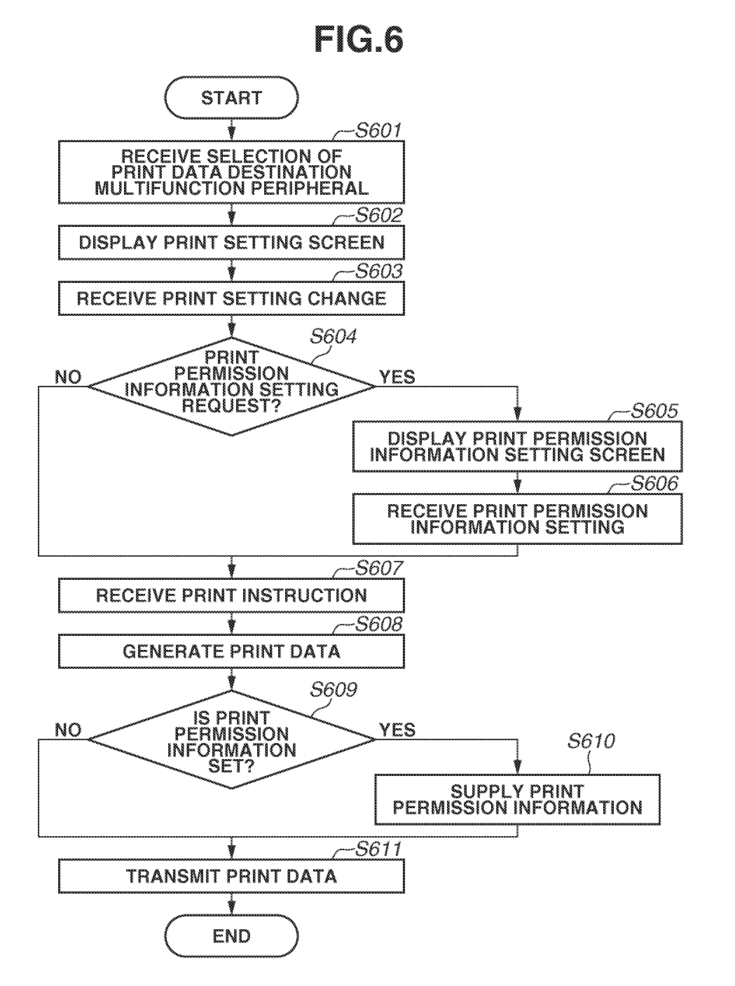

FIG. 6 is a flowchart illustrating example processing for transmitting print data from the PC 102 to the multifunction peripheral 103 according to the present exemplary embodiment.

In the present exemplary embodiment, an example case where the PC 102 transmits page description language (PDL) data as print data to the multifunction peripheral 103 will be described below. PDLs include LBP Image Processing System (LIPS) (registered trademark) and PostScript (registered trademark). The multifunction peripheral 103 interprets the PDL data and performs RIP processing on the print data. The print data may be non-PDL data. The print data may have any format as long as the multifunction peripheral 103 can interpret and print it. For example, applicable formats include Tag Image File Format (TIFF) for image data and document formats for applications 413.

In step S601, a printer driver activated from an application operating on the PC 102 (hereinafter simply referred to as a printer driver) receives a selection of a multifunction peripheral 103 as a print data destination.

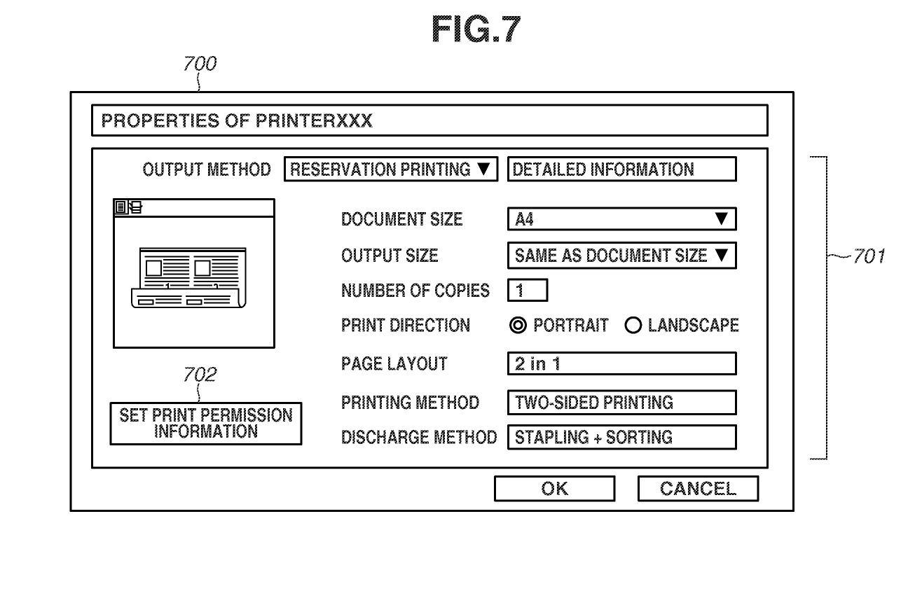

In step S602, a printer driver displays a print setting screen 700 illustrated in FIG. 7 on the image display unit 207.

FIG. 7 illustrates an example print setting screen 700.

The print setting screen 700 displays various print settings including the output size, the number of copies, the print direction, the page layout, one-sided printing, two-sided printing, and the discharge method. The user can designate the above-described print settings via the input apparatus 206.

Description of FIG. 6 will resume.

In step S603, the printer driver receives a change of a print setting via the input apparatus 206. Print settings are not limited to the ones illustrated in FIG. 7, and may be other print settings. For example, the print setting screen 700 may include a print setting which explicitly allows reservation printing to be designated as an output method.

In step S604, the printer driver determines whether a print permission information setting request has been received. When a print permission information setting request is determined to have been received (YES in step S604), the processing proceeds to step S605. On the other hand, when a print permission information setting request is determined to have not been received (NO in step S604), the processing proceeds to step S607. More specifically, when a selection (depression) of a “SET PRINT PERMISSION INFORMATION” button 702 in the print setting screen 700 is detected via the input apparatus 206, the printer driver determines that a print permission information setting request has been received.

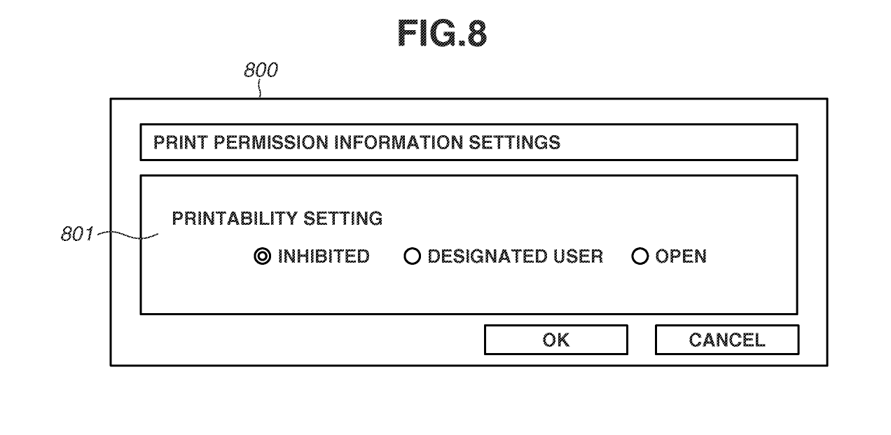

In step S605, the printer driver displays a “PRINT PERMISSION INFORMATION SETTINGS” screen 800 illustrated in FIG. 8.

FIG. 8 illustrates an example of the “PRINT PERMISSION INFORMATION SETTINGS” screen 800.

The “PRINT PERMISSION INFORMATION SETTINGS” screen 800 indicates that settings “INHIBITED”, “DESIGNATED USER”, and “OPEN” can be selected as a “PRINTABILITY SETTING” 801 for setting a print permission to other users. The user can designate any one of the above-described settings via the input apparatus 206. Then, the printer driver receives the printability setting 507 via the input apparatus 206. “INHIBITED” means that printing by other users is inhibited. “DESIGNATED USER” means that printing by a designated user is permitted. “OPEN” means that printing by other users including undesignated users is permitted.

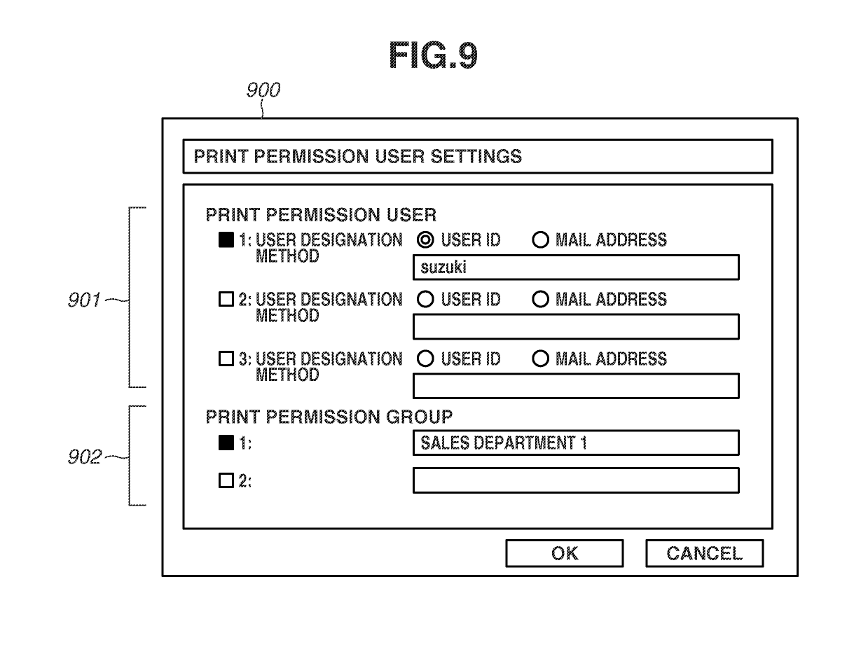

For example, upon reception of a selection of “DESIGNATED USER” for the “PRINTABILITY SETTING” 801 via the input apparatus 206, the printer driver displays a “PRINT PERMISSION USER SETTINGS” screen 900 illustrated in FIG. 9 on the image display unit 207.

FIG. 9 illustrates an example of the “PRINT PERMISSION USER SETTINGS” screen 900.

The “PRINT PERMISSION USER SETTINGS” screen 900 indicates that “PRINT PERMISSION USERS” 901 and “PRINT PERMISSION GROUPS” 902 can be designated as print permission targets. For the “PRINT PERMISSION USERS” 901, each user can be designated by using either the user ID or the mail address. However, the user designation method is not limited thereto, and the employee number, the display name, and other user ID information may be used to designate each user. The printer driver receives designations of the “PRINT PERMISSION USERS” 901 and designations of the “PRINT PERMISSION GROUPS” 902 via the input apparatus 206.

Description of FIG. 6 will resume.

In step S606, the printer driver receives print permission information settings via the input apparatus 206.

In step S607, the printer driver receives a print instruction via the input apparatus 206.

In step S608, the printer driver converts application data into PDL data according to designated print settings to generate print data including the owner information. An owner refers to a user (supplier) who generates the above-described print data via the PC 102, and enters it in the multifunction peripheral 103.

In step S609, the printer driver determines whether the print permission information has been set by the user. When it is determined that the print permission information has been set (YES in step S609), the processing proceeds to step S610. On the other hand, when it is determined that the print permission information has not been set (NO in step S609), the processing proceeds to step S611.

In step S610, the printer driver generates print data by supplying (appending) the print permission information with respect to the print permission information settings to the print data generated in step S608. The print permission information to be supplied to the print data by the printer driver is example related information about print control for the print data.

In step S611, the printer driver transmits the generated print data to the multifunction peripheral 103.

With the above-described processing, the above-described supplier can designate a target of print output permission for the print data to be entered in the multifunction peripheral 103 via the PC 102.

### (Print Data Reception Processing Procedure)

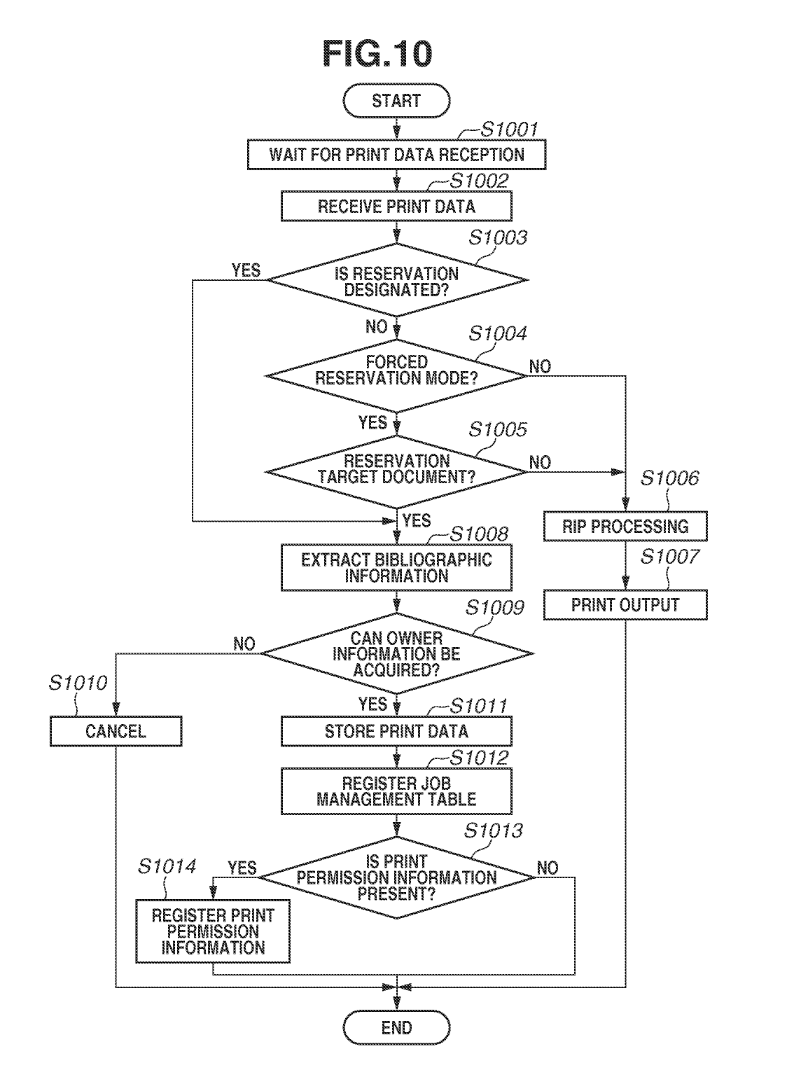

FIG. 10 is a flowchart illustrating example print data reception processing performed by the multifunction peripheral 103 according to the present exemplary embodiment.

In step S1001, the job device control 404 waits for reception of print data.

In step S1002, the job device control 404 receives print data via the network I/F 310, and notifies the application 414 of the reception.

In step S1003, the application 414 determines whether the received print data is designated for reservation printing as an output method. When it is determined that the received print data is designated for reservation printing (YES in step S1003), the processing proceeds to step S1008. On the other hand, when it is determined that the received print data is undesignated for reservation printing (NO in step S1003), the processing proceeds to step S1004.

In step S1004, the application 414 determines whether the multifunction peripheral 103 is in the forced reservation mode. When the multifunction peripheral 103 is determined to be in the forced reservation mode (YES in step S1004), the processing proceeds to step S1005. On the other hand, when the multifunction peripheral 103 is determined to be not in the forced reservation mode (NO in step S1004), the processing proceeds to step S1006. The forced reservation mode is a mode in which the multifunction peripheral 103 outputs a print product in the reservation print mode regardless of the received print data.

In step S1005, the application 414 determines whether the received print data is a reservation target document. When the received print data is determined to be a reservation target document (YES in step S1005), the processing proceeds to step S1008. On the other hand, when the received print data is determined to be not a reservation target document (NO in step S1005), the application 414 notifies the job device control 404 of the relevant fact. Then, the processing proceeds to step S1006. More specifically, the application 414 determines whether the received print data is a reservation target document based on the PDL data type and the print request source information included in the print data. The application 414 does not need to perform all of the processing in steps S1003 to S1005. For example, the application 414 may perform the processing in one of or any combination of steps S1003 to S1005.

In step S1006, the job device control 404 performs RIP processing on the PDL data included in the print data according to the print settings.

In step S1007, the job device control 404 instructs the printer unit 309 to perform printing via the device I/F 307, thus performing print output.

In step S1008, the application 414 extracts bibliographic information from the received print data.

In step S1009, the application 414 determines whether the owner information can be acquired from the print data. When it is determined that the owner information can be acquired (YES in step S1009), the processing proceeds to step S1011. On the other hand, when it is determined that the owner information cannot be acquired (NO in step S1009), the processing proceeds to step S1010. More specifically, the application 414 determines that the owner information can be acquired when the owner information is included in the bibliographic information extracted in step S1008.

In step S1010, the application 414 cancels the processing, and the processing exits the flowchart.

In step S1011, the application 414 requests the file system 403 to store the print data in the HDD 304. Then, the file system 403 stores the print data in the HDD 304.

In step S1012, the application 414 transmits the owner information acquired in step S1009 and the print data stored in step S1011 to the job management unit 412. Then, the job management unit 412 appends bibliographic information of a designated user to the job management table 500.

In step S1013, the application 414 determines whether the print permission information has been supplied. When it is determined that the print permission information has been supplied (YES in step S1013), the processing proceeds to step S1014. On the other hand, when it is determined that the print permission information has not been supplied (NO in step S1013), the processing exits the flowchart.

In step S1014, the application 414 notifies the job management unit 412 that the print permission information has been supplied. Then, the job management unit 412 registers the print permission information in designated bibliographic information in the job management table 500, and the processing exits the flowchart.

The above-described processing enables the multifunction peripheral 103 to use the owner information and the print permission information registered together with the print data in reservation printing of the print data entered from the PC 102.

### (Print Processing Procedure)

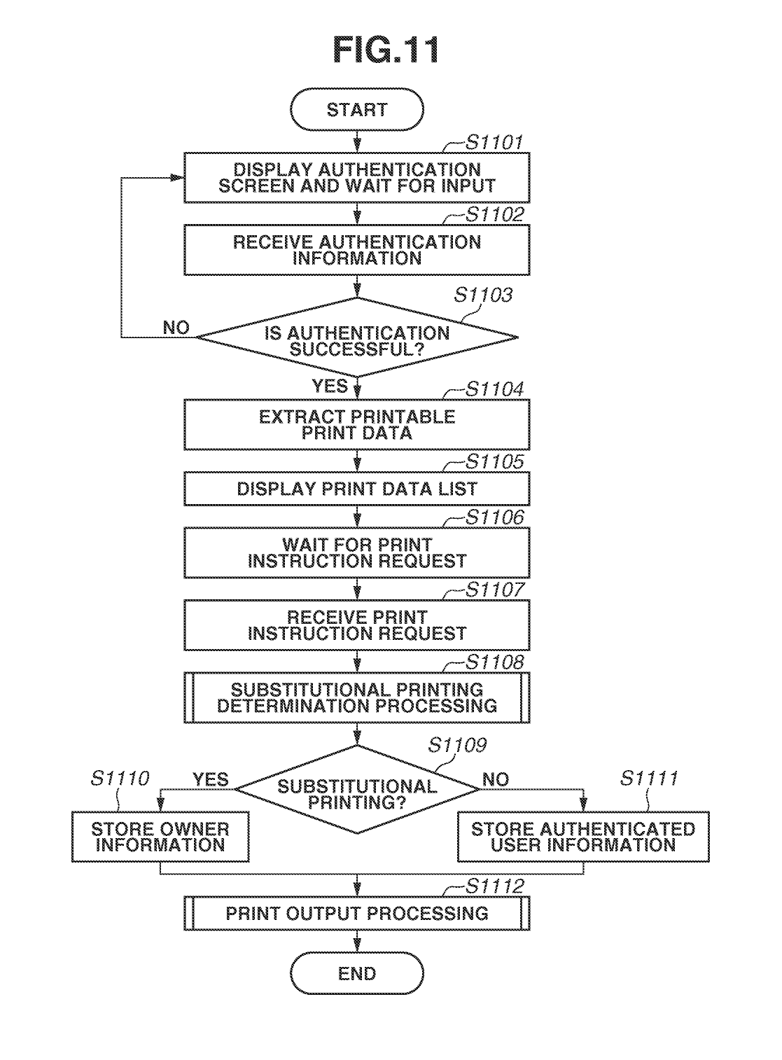

FIG. 11 is a flowchart illustrating example print processing performed by the multifunction peripheral 103 according to the present exemplary embodiment.

In step S1101, the authentication service 410 displays an authentication screen on the operation unit 306, and waits until authentication information is input via the operation unit 306.

In step S1102, the operation unit I/F 305 transmits a user input received via the operation unit 306 to the authentication service 410 as authentication information. Then, the authentication service 410 receives the authentication information.

In step S1103, the authentication service 410 performs user authentication, and determines whether authentication has succeeded. When authentication is determined to have succeeded (YES in step S1103), the authentication service 410 notifies the applications 413 and 414 of the result of the authentication, and the processing proceeds to step S1104. On the other hand, when it is determined that the authentication has failed (NO in step S1103), the processing returns to step S1101. The authentication processing has been described above with reference to FIG. 4, and detailed description will be omitted.

In step S1104, the application 414 acquires bibliographic information from the job management unit 412, and extracts print data printable by the authenticated user.

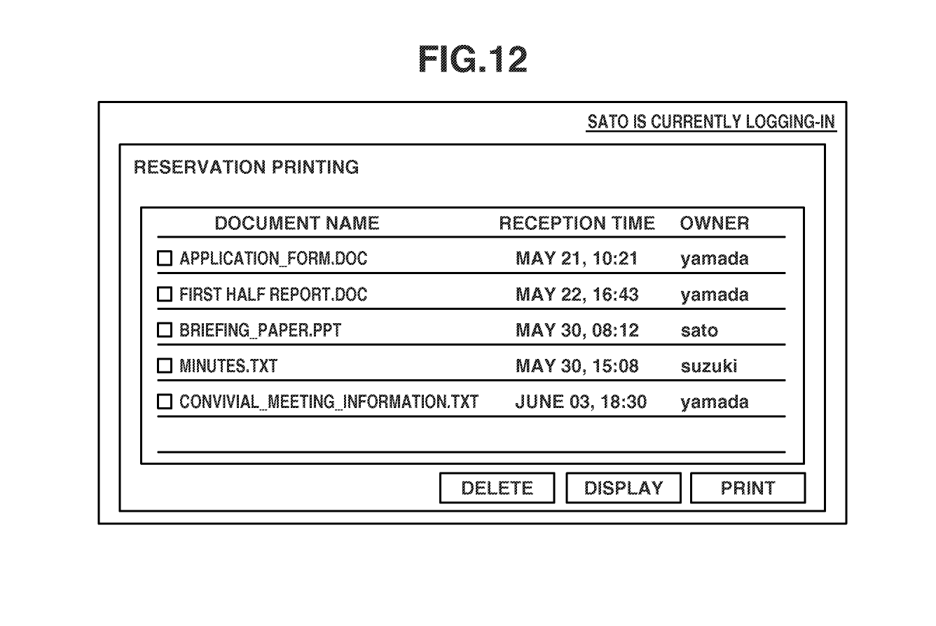

In step S1105, the application 414 displays a print data list of printable data illustrated in FIG. 12 on the operation unit 306.

FIG. 12 illustrates an example print data list.

For example, assume that the authenticated user is “sato” who belongs to a group “team A”. In this case, the application 414 extracts five different print data illustrated in FIG. 12 from the job management table 500 illustrated in FIG. 5 as print data printable by “sato”, and displays the print data on the operation unit 306 as a print data list.

Description of FIG. 11 will resume.

In step S1106, the application 414 waits until it receives a selection of print data and an input of a print instruction request via the operation unit 306.

In step S1107, the operation unit I/F 305 transmits to the application 414 a print instruction request for the print data selected by the user via the operation unit 306. Then, the application 414 receives the print instruction request.

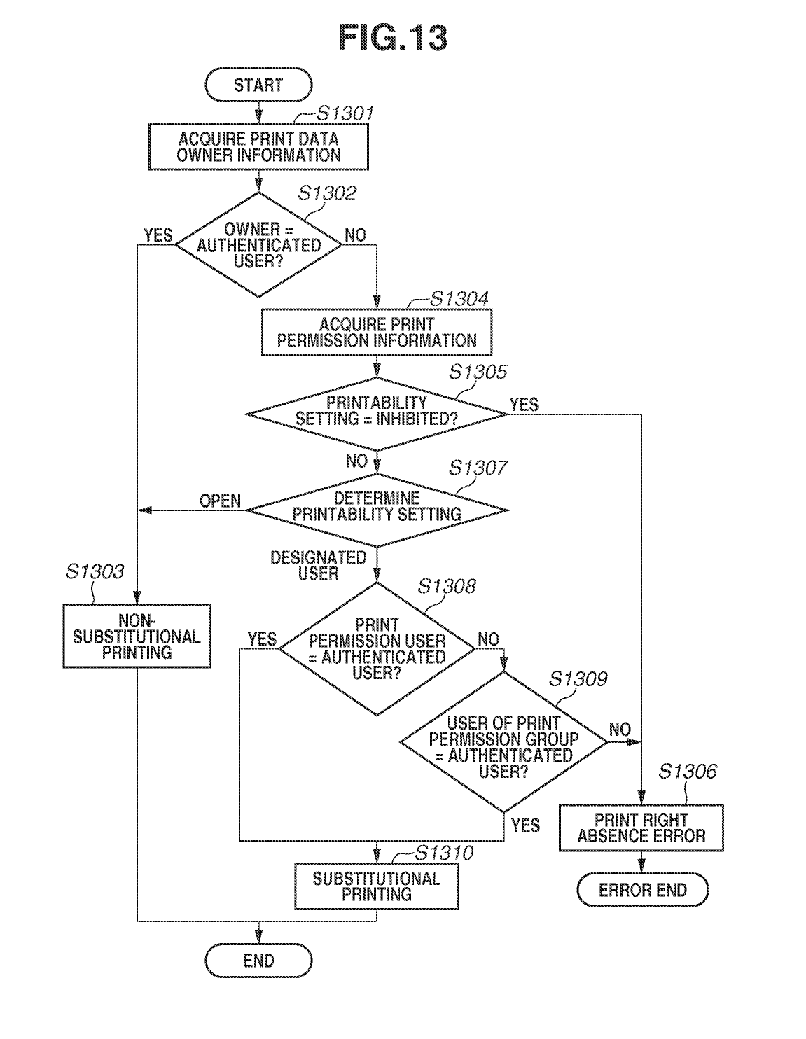

In step S1108, the application 414 performs substitutional printing determination processing. Substitutional printing refers to a printing method in which, according to an instruction of a representative permitted as a substitute of the owner who entered print data, the multifunction peripheral 103 performs print processing for the relevant print data. The processing in step S1108 will be described in detail below with reference to FIG. 13.

In step S1109, the application 414 confirms the determination result of the substitutional printing determination processing. When it is determined that substitutional printing is designated (YES in step S1109), the processing proceeds to step S1110. On the other hand, when substitutional printing is undesignated (NO in step S1109), the processing proceeds to step S1111.

In step S1110, the application 414 stores the owner information as user information to be used at the time of print output.

In step S1111, the application 414 stores authenticated user information as user information to be used at the time of print output.

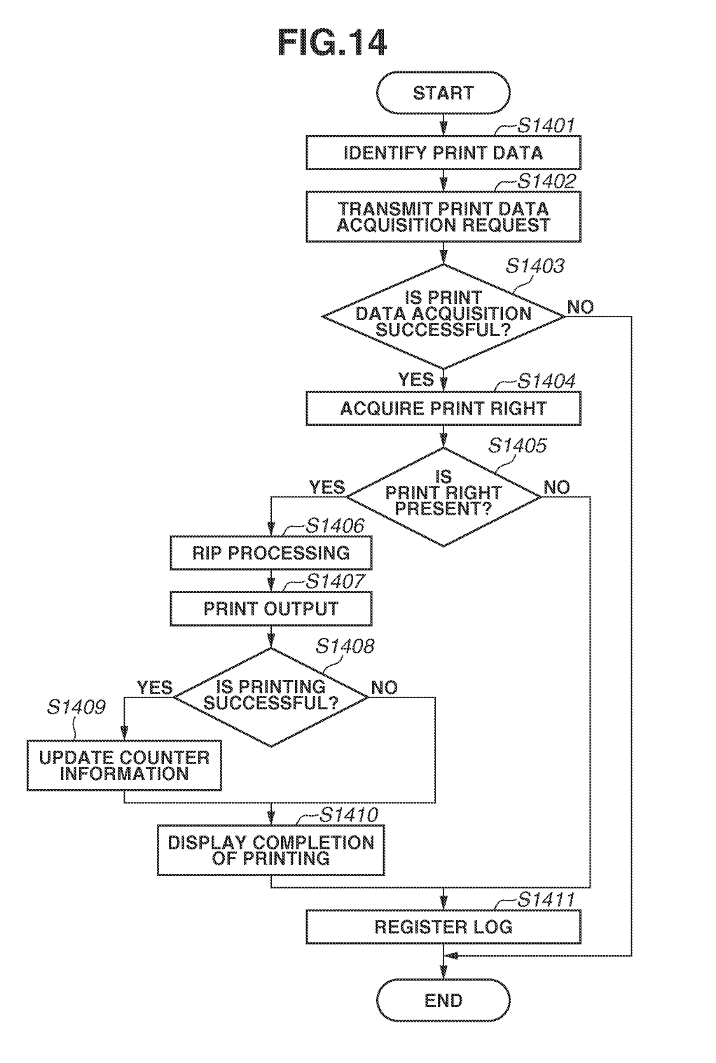

In step S1112, the application 414 performs print output processing, and the processing exits the flowchart. The processing in step S1112 will be described in detail below with reference to FIG. 14.

The above processing enables the multifunction peripheral 103 to store suitable user information to be used for the print output processing depending on whether substitutional printing is designated as a printing method for the entered print data. Specifically, the multifunction peripheral 103 can perform the print output processing by using suitable user information.

### (Substitutional Printing Determination Processing)

FIG. 13 is a flowchart illustrating example substitutional printing determination processing performed by the multifunction peripheral 103 according to the present exemplary embodiment.

In step S1301, the application 414 acquires the owner information for the print data from the job management unit 412.

In step S1302, the application 414 determines whether the owner of the print data coincides with the authenticated user. When it is determined that the owner of the print data coincides with the authenticated user (YES in step S1302), the processing proceeds to step S1303. On the other hand, when it is determined that the owner of the print data does not coincide with the authenticated user (NO in step S1302), the processing proceeds to step S1304.

In step S1303, the application 414 determines that substitutional printing is undesignated, i.e., non-substitutional printing is designated.

In step S1304, the application 414 acquires the print permission information associated with the print data from the job management unit 412.

In step S1305, the application 414 determines whether the printability setting 507 indicated by the print permission information acquired in step S1304 is “INHIBITED”. When the printability setting 507 is determined to be “INHIBITED” (YES in step S1305), the processing proceeds to step S1306. On the other hand, when the printability setting 507 is determined to be not “INHIBITED” (NO in step S1305), the processing proceeds to step S1307.

In step S1306, the application 414 determines a print right absence error for the login user, and proceeds to the processing illustrated in FIG. 13 as error end processing.

In step S1307, the application 414 determines whether the printability setting 507 is “OPEN” or “DESIGNATED USER”. When the printability setting 507 is determined to be “OPEN” in step S1307, the processing proceeds to step S1303. On the other hand, when the printability setting 507 is determined to be “DESIGNATED USER” in step S1307, the processing proceeds to step S1308.

In step S1308, the application 414 determines whether the print permission user indicated by the print permission information coincides with the authenticated user. When it is determined that the relevant print permission user coincides with the authenticated user (YES in step S1308), the processing proceeds to step S1310. On the other hand, when it is determined that the relevant print permission user does not coincide with the authenticated user (NO in step S1308), the processing proceeds to step S1309.

In step S1309, the application 414 determines whether the user who constitutes the print permission group indicated by the print permission information coincides with the authenticated user. When it is determined that the relevant user coincides with the authenticated user (YES in step S1309), the processing proceeds to step S1310. On the other hand, when it is determined that the relevant user does not coincide with the authenticated user (NO in step S1309), the processing proceeds to step S1306. The application 414 does not need to perform all of the processing in steps S1308 and S1309. For example, the application 414 may perform the processing in either one of steps S1308 and S1309.

In step S1310, the application 414 determines that substitutional printing is designated, and the processing exits the flowchart illustrated in FIG. 13.

The above-described processing enables the multifunction peripheral 103 to determine whether the instructor who gives an instruction to print the print data entered from the PC 102 is a representative. Specifically, the multifunction peripheral 103 can determine whether the above-described printing is substitutional printing.

### (Print Output Processing)

FIG. 14 is a flowchart illustrating example print output processing performed by the multifunction peripheral 103 according to the present exemplary embodiment.

In step S1401, the application 414 identifies print data based on the bibliographic information of the print data selected via the operation unit 306.

In step S1402, the application 414 transmits a print data acquisition request to the file system 403.

In step S1403, the application 414 determines whether print data acquisition has succeeded. When it is determined that print data acquisition has succeeded (YES in step S1403), the processing proceeds to step S1404. On the other hand, when it is determined that print data acquisition has failed (NO in step S1403), the processing exits the flowchart.

In step S1404, the application 414 acquires from the authority management unit 411 print right information of the user prestored as the user information to be used at the time of print output. More specifically, when substitutional printing is designated, the application 414 acquires as print right information the owner information stored in step S1110. When substitutional printing is undesignated, the application 414 acquires as authority information the authenticated user information stored in step S1111.

In step S1405, the application 414 compares the print right indicated by the print right information acquired in step S1404 with the print setting set in the print data to determine whether the print right is present. When the print right is determined to be present (YES in step S1405), the application 414 notifies the job device control 404 of print output, and the processing proceeds to step S1406. On the other hand, when the print right is determined to be absent (NO in step S1405), the processing proceeds to step S1411.

In step S1406, the job device control 404 performs the RIP processing on the PDL data included in the print data according to the print settings.

In step S1407, the job device control 404 transmits a print instruction to the printer unit 309 via the device I/F 307 to perform print output.

In step S1408, the application 414 determines whether print output has succeeded. When it is determined that print output has succeeded (YES in step S1408), the processing proceeds to step S1409. On the other hand, when it is determined that print output has failed (NO in step S1408), the processing proceeds to step S1410.

In step S1409, the application 414 transmits to the counter 405 a counter information update request for the user prestored as user information to be used at the time of print output. More specifically, when substitutional printing is designated, the application 414 transmits a counter information update request for the owner of the print data. When substitutional printing is undesignated, the application 414 transmits a counter information update request for the authenticated user. Then, the counter 405 updates the requested counter information.

In step S1410, the application 414 displays the completion of printing on the operation unit 306.

In step S1411, the application 414 transmits to the log 406 a log registration request with the user information prestored as user information to be used at the time of print output. More specifically, when substitutional printing is designated, the application 414 transmits a log registration request with the user information of the owner of the print data. When substitutional printing is undesignated, the application 414 transmits a log registration request with the user information of the authenticated user. Then, the log 406 registers the log according to the request, and the processing exits the flowchart.

The above-described processing enables the multifunction peripheral 103 to perform printing by using suitable user information, i.e., suitable user authority information depending on whether substitutional printing is designated. The multifunction peripheral 103 can suitably update the counter information and register a log depending on whether substitutional printing is designated.

As described above, according to the present exemplary embodiment, the multifunction peripheral 103 can determine whether substitutional printing is designated according to the print permission information input by the supplier of the print data, and perform print control by using suitable user information. Thus, the multifunction peripheral 103 can perform printing based on suitable authority. Further, the multifunction peripheral 103 can update the counter information and register a log for a suitable user.

A printing system according to a second exemplary embodiment will be described below.

The printing system configuration, the hardware configuration of the PC 102, the hardware configuration of the multifunction peripheral 103, and the software configuration of the multifunction peripheral 103 according to the present exemplary embodiment are similar to those according to the first exemplary embodiment, and redundant descriptions thereof will be omitted.

Further, the print data transmission procedure of the PC 102 is as described in the flowchart illustrated in FIG. 6 according to the first exemplary embodiment. The print data reception processing procedure of the multifunction peripheral 103 is as described in the flowchart illustrated in FIG. 10 according to the first exemplary embodiment. The print processing procedure of the multifunction peripheral 103 is as described in the flowchart illustrated in FIG. 11 according to the first exemplary embodiment. The print output processing procedure of the multifunction peripheral 103 is as described in the flowchart illustrated in FIG. 14 according to the first exemplary embodiment. Details of the above-described processing are described in the first exemplary embodiment, and redundant descriptions thereof will be omitted.

### (Substitutional Printing Determination Processing)

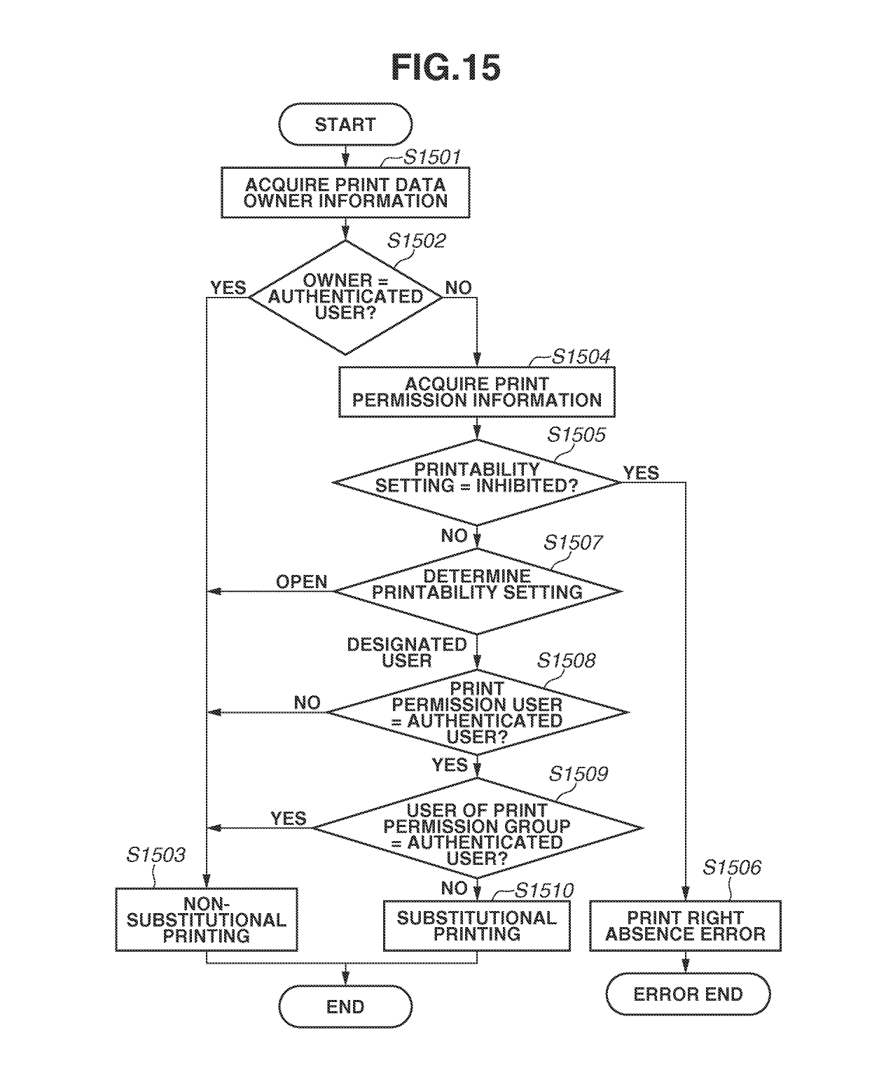

FIG. 15 is a flowchart illustrating example substitutional printing determination processing performed by the multifunction peripheral 103 according to the present exemplary embodiment.

The processing in steps S1501 to S1507 is similar to the processing in steps S1301 to step S1307 illustrated in FIG. 13, and redundant descriptions thereof will be omitted.

In step S1508, the application 414 determines whether the print permission user indicated by the print permission information coincides with the authenticated user. When it is determined that the relevant user coincides with the authenticated user (YES in step S1508), the processing proceeds to step S1509. On the other hand, when it is determined that the relevant user does not coincide with the authenticated user (NO in step S1508), the processing proceeds to step SS1503.

In step S1509, the application 414 determines whether the user who constitutes the print permission group indicated by the print permission information coincides with the authenticated user. When it is determined that the relevant user coincides with the authenticated user (YES in step S1509), the processing proceeds to step S1503. On the other hand, when it is determined that the relevant user does not coincides with the authenticated user (NO in step S1509), the processing proceeds to step S1510.

The processing in step S1510 is similar to the processing in step S1310 illustrated in FIG. 13, and redundant description thereof will be omitted. As described above, according to the present exemplary embodiment, only when the authenticated user is designated as a print permission user, the multifunction peripheral 103 can perform print control by determining that substitutional printing is designated. Further, the multifunction peripheral 103 determines that users other than the authenticated user designated as a print permission user are not representatives, and can perform print control by using the information of the authenticated user.

A printing system according to a third exemplary embodiment will be described below.

The printing system configuration, the hardware configuration of the PC 102, the hardware configuration of the multifunction peripheral 103, and the software configuration of the multifunction peripheral 103 according to the present exemplary embodiment are similar to those according to the first exemplary embodiment, and redundant descriptions thereof will be omitted.

The print data transmission procedure of the PC 102 is as described in the flowchart illustrated in FIG. 6 according to the first exemplary embodiment. The print data reception processing procedure of the multifunction peripheral 103 is as described in the flowchart illustrated in FIG. 10 according to the first exemplary embodiment. The print processing procedure of the multifunction peripheral 103 is as described in the flowchart illustrated in FIG. 11 according to the first exemplary embodiment. The print output processing procedure of the multifunction peripheral 103 is as described in the flowchart illustrated in FIG. 14 according to the first exemplary embodiment. Details of the above-described processing are as described in the first exemplary embodiment, and redundant descriptions thereof will be omitted.

### (Substitutional Printing Determination Procedure)

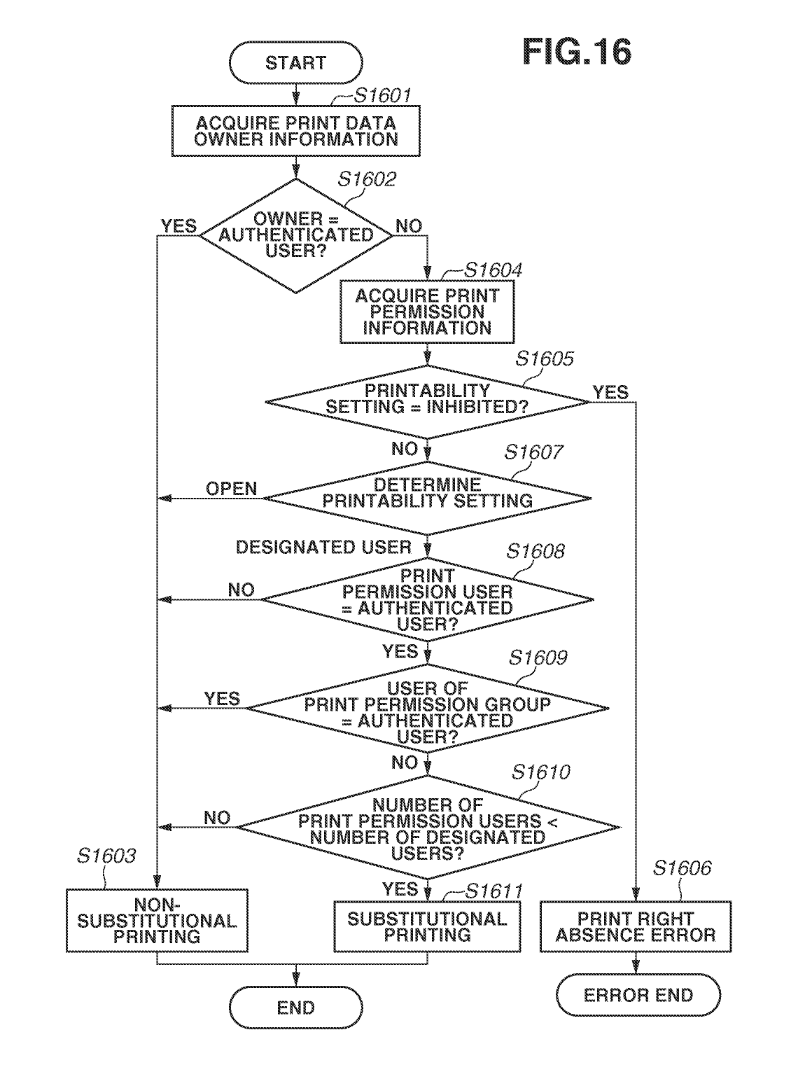

FIG. 16 is a flowchart illustrating example substitutional printing determination processing performed by the multifunction peripheral 103 according to the present exemplary embodiment.

The processing in steps S1601 to step S1609 is similar to the processing in steps S1501 to step S1509 illustrated in FIG. 15, and redundant descriptions thereof will be omitted.

In step S1610, the application 414 determines whether the number of print permission users indicated by the print permission information is smaller than a predetermined number of designated users (threshold value). When the number of relevant users is determined to be smaller than the relevant threshold value (YES in step S1610), the processing proceeds to step S1611. On the other hand, when the number of relevant users is determined to be not smaller than the relevant threshold value (NO in step S1610), the processing proceeds to step S1603.

The processing in step S1611 is similar to the processing in step S1510 illustrated in FIG. 15, and redundant description thereof will be omitted. As described above, according to the present exemplary embodiment, only when the authenticated user is designated as a print permission user, and the number of print permission users indicated by the print permission information is smaller than a predetermined threshold value, the multifunction peripheral 103 can perform print control by determining that substitutional printing is designated. Further, the multifunction peripheral 103 determines that other authenticated users are not representatives, and can perform print control by using the information of the relevant authenticated user.

A printing system according to a fourth exemplary embodiment will be described below.

The printing system configuration, the hardware configuration of the PC 102, the hardware configuration of the multifunction peripheral 103, and the software configuration of the multifunction peripheral 103 according to the present exemplary embodiment are similar to those according to the first exemplary embodiment, and redundant descriptions thereof will be omitted.

The print data transmission procedure of the PC 102 is as described in the flowchart illustrated in FIG. 6 according to the first exemplary embodiment. The print data reception processing procedure of the multifunction peripheral 103 is as described in the flowchart illustrated in FIG. 10 according to the first exemplary embodiment. The print processing procedure of the multifunction peripheral 103 is as described in the flowchart illustrated in FIG. 11 according to the first exemplary embodiment. The print output processing procedure of the multifunction peripheral 103 is as described in the flowchart illustrated in FIG. 14 according to the first exemplary embodiment. Details of the above processing are as described in the first exemplary embodiment, and redundant descriptions thereof will be omitted.

### (Substitutional Printing Determination Information)

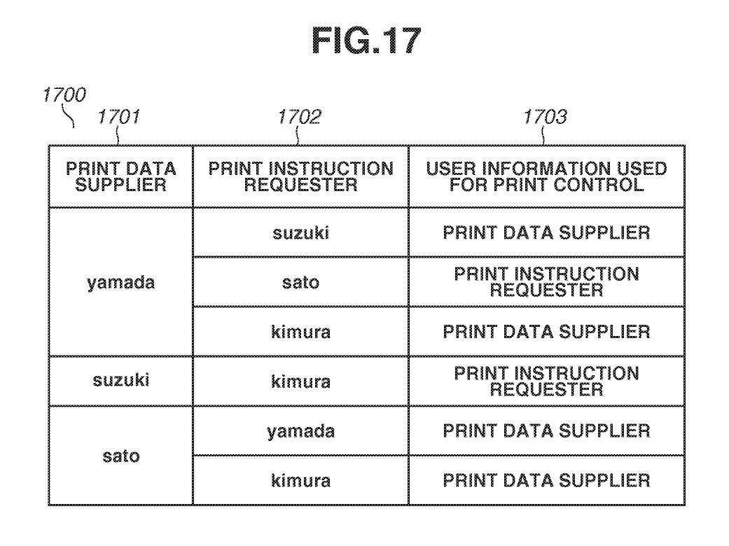

FIG. 17 illustrates example substitutional printing determination information 1700 according to the present exemplary embodiment. The substitutional printing determination information 1700 is an example combination determination condition.

The job management unit 412 stores the substitutional printing determination information 1700 in the HDD 304. The substitutional printing determination information 1700 includes information of a print data supplier (owner) 1701, information of a print instruction requester (instructor) 1702, user information 1703 used for print control.

An example case where the multifunction peripheral 103 performs print control by using the substitutional printing determination information 1700 will be described below. Suppose that the multifunction peripheral 103 receives from the print instruction requester 1702 via the operation unit 306 a print instruction request for the print data entered by the print data supplier 1701. In this case, the multifunction peripheral 103 performs print output by using the user information 1703 used for print control corresponding to the combination of the print data supplier 1701 and the print instruction requester 1702. The multifunction peripheral 103 may register the substitutional printing determination information 1700 entered via the operation unit 306, or register the substitutional printing determination information 1700 received from the PC 102 connected via a network.

### (Substitutional Printing Determination Processing Procedure)

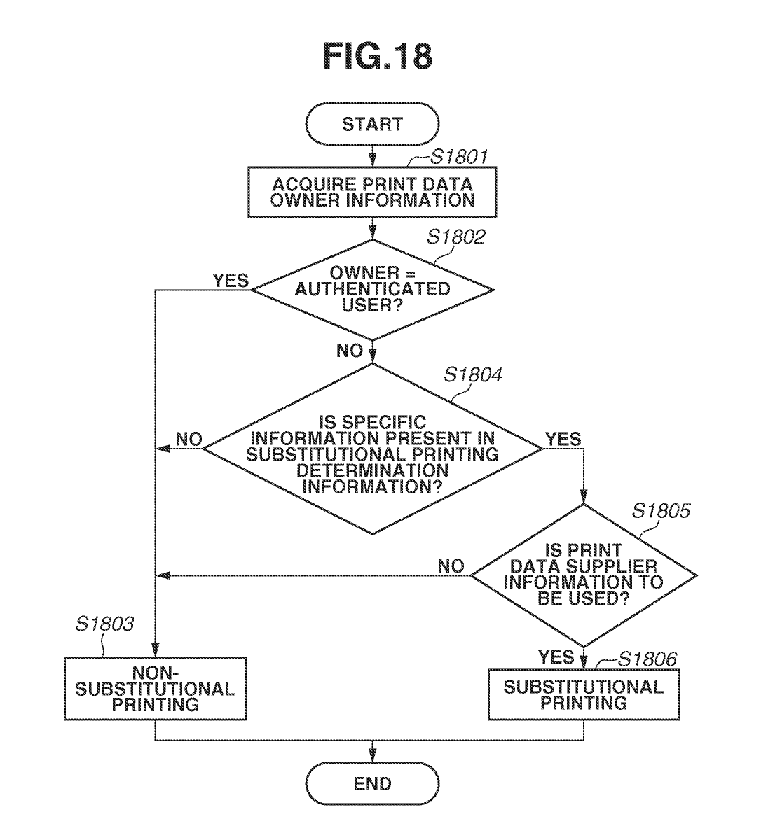

FIG. 18 is a flowchart illustrating example substitutional printing determination processing performed by the multifunction peripheral 103 according to the present exemplary embodiment.

The processing in steps S1801 to S1803 is similar to the processing in steps S1301 to S1303 illustrated in FIG. 13, and redundant descriptions thereof will be omitted.

In step S1804, the application 414 acquires the substitutional printing determination information 1700 from the job management unit 412, and determines whether information corresponding to the combination of the owner of the print data and the authenticated user is present. When information corresponding to the relevant combination is determined to be present (YES in step S1804), the processing proceeds to step S1805. On the other hand, when information corresponding to the relevant combination is determined to be absent (NO in step S1804), the processing proceeds to step S1803.

In step S1805, the application 414 checks the user information 1703 to be used for print control corresponding to the relevant combination to determine whether print data supplier information is to be used for print control. When the print data supplier information is determined to be used for print control (YES in step S1805), the processing proceeds to step S1806. On the other hand, when the print data supplier information is determined to be not used for print control (NO in step S1805), the processing proceeds to step S1803. More specifically, the application 414 checks the user information 1703 to be used for relevant print control. When print instruction requester information is defined to be used for print control (NO in step S1805), the processing proceeds to step S1803. On the other hand, when the print data supplier information is defined to be used for print control (YES in step S1805), the processing proceeds to step S1806.

The processing in step S1806 is similar to the processing in step S1310 illustrated in FIG. 13, and redundant description thereof will be omitted. As described above, according to the present exemplary embodiment, the multifunction peripheral 103 can determine whether substitutional printing is designated according to the preregistered substitutional printing determination condition, and perform print control reflecting the intentions of the user and the administrator.

A printing system according to a fifth exemplary embodiment will be described below.

The printing system configuration, the hardware configuration of the PC 102, the hardware configuration of the multifunction peripheral 103, and the software configuration of the multifunction peripheral 103 according to the present exemplary embodiment are similar to those according to the first exemplary embodiment, and redundant descriptions thereof will be omitted.

The print data transmission procedure of the PC 102 is as described in the flowchart illustrated in FIG. 6 according to the first exemplary embodiment. The print data reception processing procedure of the multifunction peripheral 103 is as described in the flowchart illustrated in FIG. 10 according to the first exemplary embodiment. The print processing procedure of the multifunction peripheral 103 is as described in the flowchart illustrated in FIG. 11 according to the first exemplary embodiment. The print output processing procedure of the multifunction peripheral 103 is as described in the flowchart illustrated in FIG. 14 according to the first exemplary embodiment. Details of the above-described processing is as described in the first exemplary embodiment, and redundant descriptions thereof will be omitted.

### (Specific Print Job Name Information)

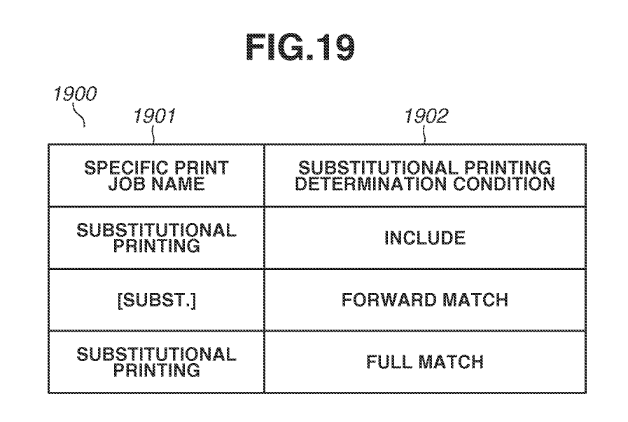

FIG. 19 illustrates example specific print job name information 1900 according to the present exemplary embodiment. The specific print job name information 1900 indicates an example job name determination condition.

The job management unit 412 stores the specific print job name information 1900 in the HDD 304. The specific print job name information 1900 includes information about a specific print job name 1901 and a substitutional printing determination condition 1902.

When the print job name included in the print data satisfies the substitutional printing determination condition defined in the specific print job name information 1900, the multifunction peripheral 103 determines that substitutional printing is designated. For example, referring to the example illustrated in FIG. 19, when “substitutional” is included in the print job name, the multifunction peripheral 103 determines that substitutional printing is designated. The multifunction peripheral 103 may register the specific print job name information 1900 input via the operation unit 306, or register the specific print job name information 1900 received from the PC 102 connected via a network.

### (Substitutional Printing Determination Processing Procedure)

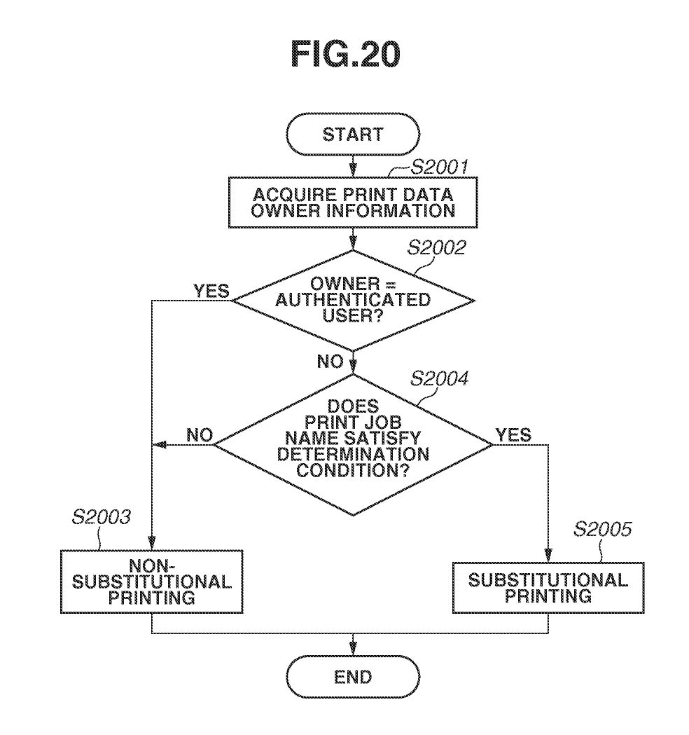

FIG. 20 is a flowchart illustrating example substitutional printing determination processing performed by the multifunction peripheral 103 according to the present exemplary embodiment.

The processing in steps S2001 to S2003 is similar to the processing in steps S1801 to S1803 illustrated in FIG. 18, and redundant descriptions thereof will be omitted.

In step S2004, the application 414 acquires the specific print job name information 1900 from the job management unit 412, and determines whether the print job name in the print data satisfies the substitutional printing determination condition defined in the specific print job name information 1900. When it is determined that the print job name satisfies the substitutional printing determination condition (YES in step S2004), the processing proceeds to step S2005. On the other hand, when it is determined that the print job name does not satisfy the substitutional printing determination condition (NO in step S2004), the processing proceeds to step S2003.

The processing in step S2005 is similar to the processing in step S1806 illustrated in FIG. 18, and redundant description thereof will be omitted. As described above, according to the present exemplary embodiment, the multifunction peripheral 103 can utilize substitutional printing and normal printing in a selective way as intended by the user, enabling more flexible print control.

A printing system according to a sixth exemplary embodiment will be described below.

The printing system configuration, the hardware configuration of the PC 102, the hardware configuration of the multifunction peripheral 103, and the software configuration of the multifunction peripheral 103 according to the present exemplary embodiment are similar to those according to the first exemplary embodiment, and redundant descriptions thereof will be omitted.

### (Job Control Information Setting)

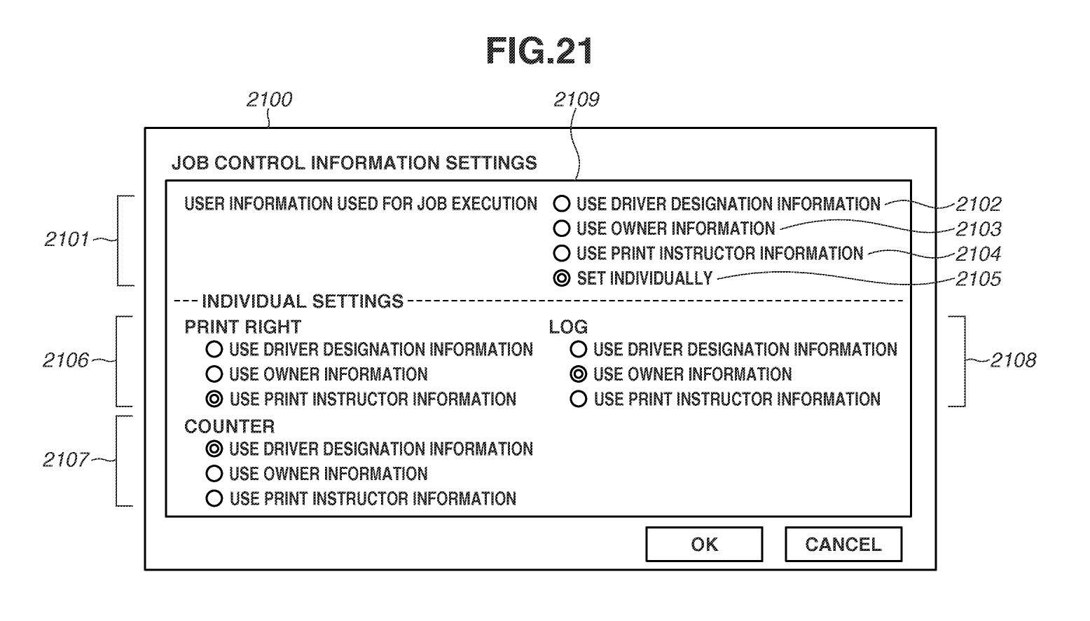

FIG. 21 illustrates an example of a “JOB CONTROL INFORMATION SETTINGS” screen (input screen) 2100 of the multifunction peripheral 103 according to the present exemplary embodiment.

The application 414 of the multifunction peripheral 103 displays the “JOB CONTROL INFORMATION SETTINGS” screen 2100 on the operation unit 306 via the operation unit I/F 305. The user and the administrator of the multifunction peripheral 103 can make in the “JOB CONTROL INFORMATION SETTINGS” screen 2100 displayed on the operation unit 306 job control information settings 2109 which are the user information to be used at the time of print output. The information about the job control information settings 2109 is example first control information.

As the user information 2101 to be used at the time of job execution, the user selects any one of “USE DRIVER DESIGNATION INFORMATION” 2102, “USE OWNER INFORMATION” 2103, and “USE PRINT INSTRUCTOR INFORMATION” 2104, or “SET INDIVIDUALLY” 2105 via the operation unit 306. When the user selects “SET INDIVIDUALLY” 2105 via the operation unit 306, the user can further individually set information to be used for “PRINT RIGHT” 2106, “COUNTER” 2107, and “LOG” 2108. The application 414 stores in the HDD 304 the information about the job control information settings 2109 received via the operation unit 306.

### (Print Data Transmission Procedure of PC 102)

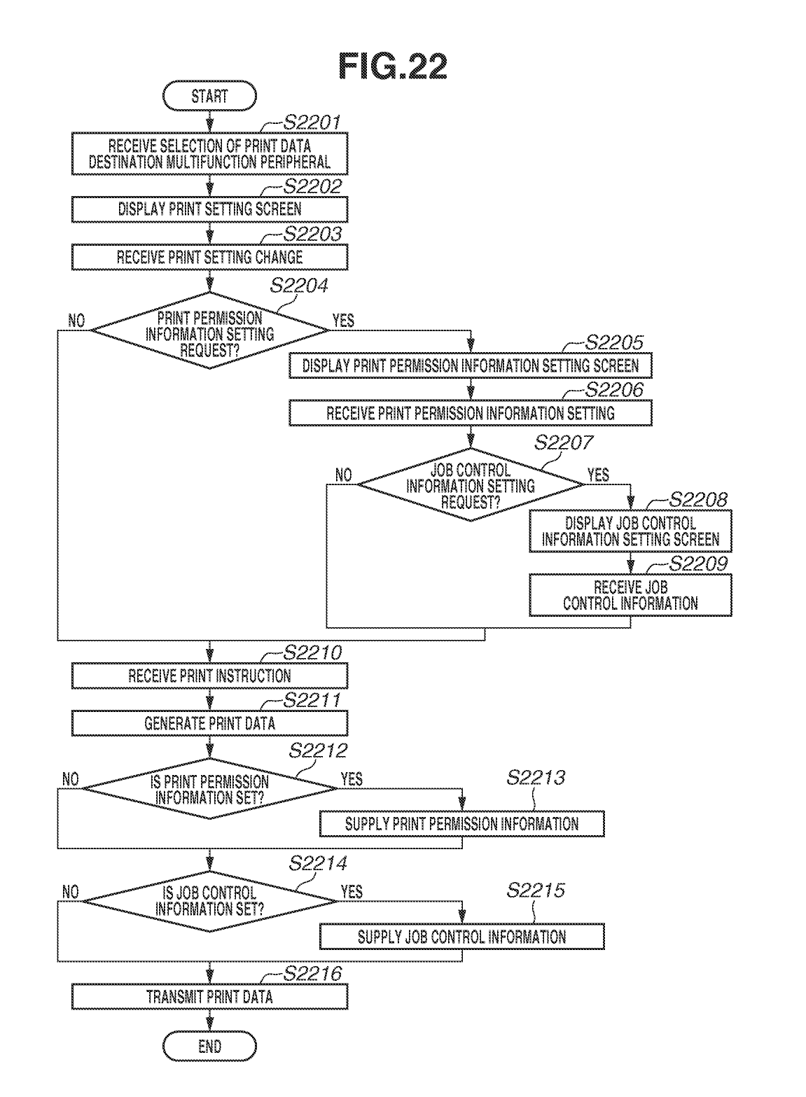

FIG. 22 is a flowchart illustrating example processing for transmitting print data from the PC 102 to the multifunction peripheral 103 according to the present exemplary embodiment.

The processing in steps S2201 to S2206 is similar to the processing in steps S601 to S606 illustrated in FIG. 6, and redundant descriptions thereof will be omitted.

In step S2207, the printer driver determines whether a job control information setting request has been received. When a job control information setting request is determined to have been received (YES in step S2207), the processing proceeds to step S2208. On the other hand, when a job control information setting request is determined to have not been received (NO in step S2207), the processing proceeds to step S2210. More specifically, upon reception of a selection of a control information setting button via the input apparatus 206, the printer driver determines that a job control information setting request has been received.

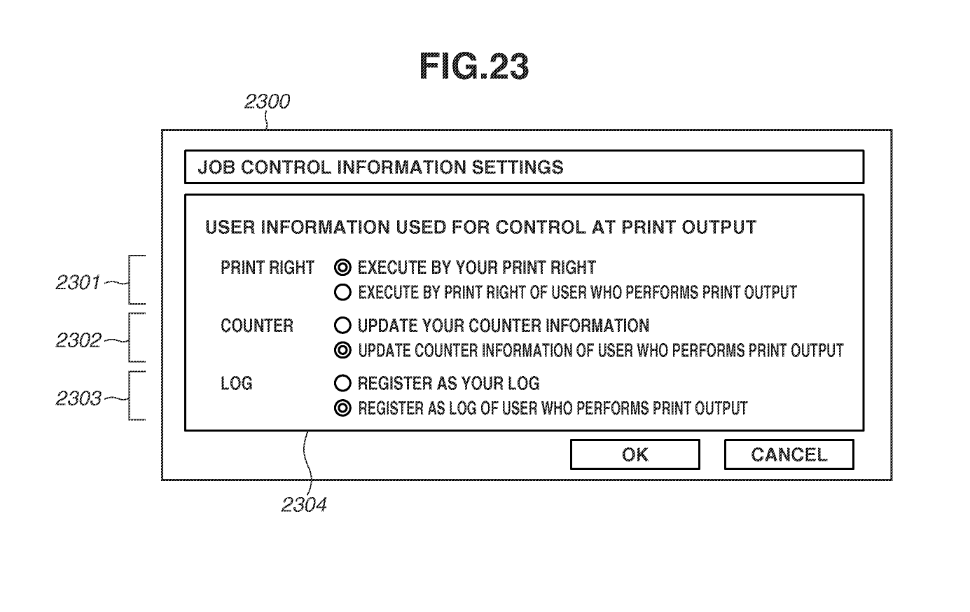

In step S2208, the printer driver displays a “JOB CONTROL INFORMATION SETTINGS” screen 2300 illustrated in FIG. 23 on the image display unit 207.

FIG. 23 illustrates an example of the “JOB CONTROL INFORMATION SETTINGS” screen 2300 of the PC 102.

The “JOB CONTROL INFORMATION SETTINGS” screen 2300 indicates settings related to “PRINT RIGHT” 2301, “COUNTER” 2302, and “LOG” 2303 as the job control information settings 2304 which are settings of the user information to be used at the time of print data output. The information about the job control information settings 2304 is example second control information.

Description of FIG. 22 will resume.

In step S2209, the printer driver receives the information about the job control information settings 2304.

The processing in steps S2210 to S2213 is similar to the processing in steps S607 to S610 illustrated in FIG. 6, and redundant descriptions thereof will be omitted.

In step S2214, the printer driver determines whether the job control information settings 2304 has been set by the user. When the job control information settings 2304 are determined to have been set (YES in step S2214), the processing proceeds to step S2215. On the other hand, when the job control information settings 2304 are determined to have not been set (NO in step S2214), the processing proceeds to step S2216.

In step S2215, the printer driver supplies the information about the job control information settings 2304 to the print data generated in step S2211. The information about the job control information settings 2304 to be supplied to the print data by the printer driver is example information related to print control of the print data.

The processing in step S2216 is similar to the processing in step S611 illustrated in FIG. 6, and redundant description thereof will be omitted.

The above-described processing enables the supplier of the print data to designate print data target entered in the multifunction peripheral 103 via the PC 102, to permit its output, and to make job control setting as intended by the supplier.

### (Print Data Reception Processing Procedure)

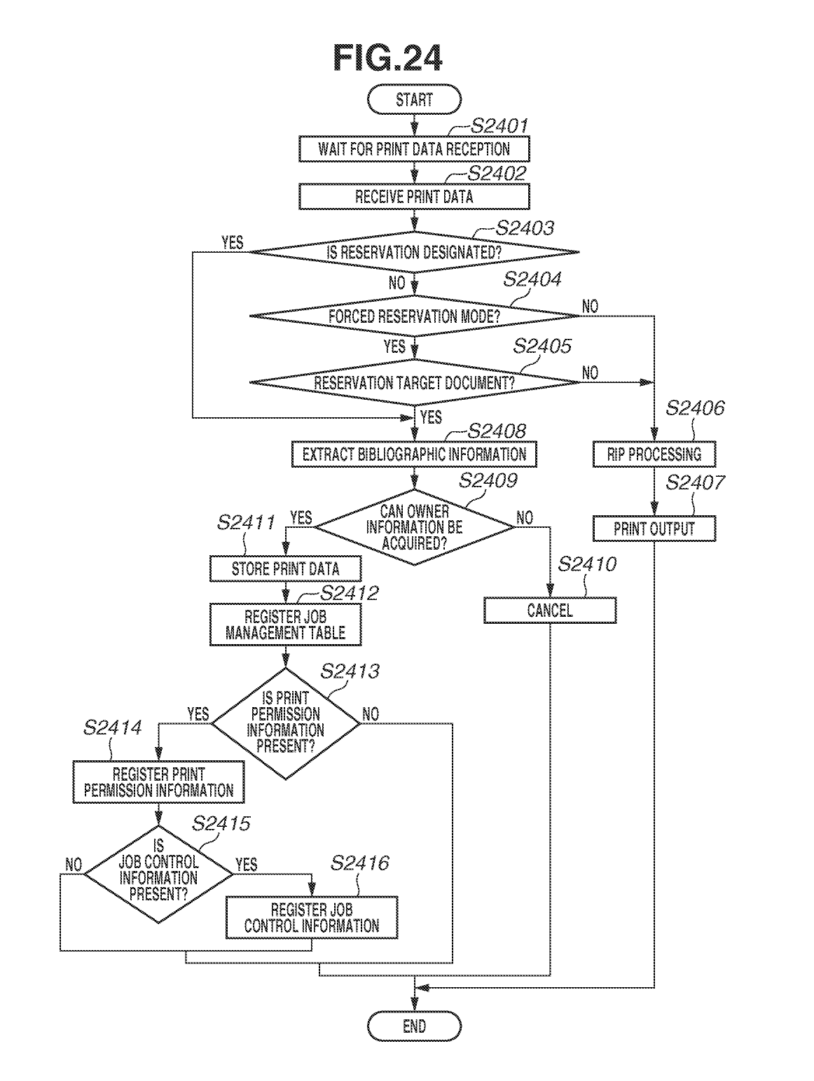

FIG. 24 is a flowchart illustrating example print data reception processing performed by the multifunction peripheral 103 according to the present exemplary embodiment.

The processing in steps S2401 to S2414 is similar to the processing in steps S1001 to S1014 illustrated in FIG. 10, and redundant descriptions thereof will be omitted.

In step S2415, the application 414 determines whether the information about the job control information settings 2304 is supplied to the print data. When it is determined that the relevant information has been supplied to the print data (YES in step S2415), the processing proceeds to step S2416. On the other hand, when it is determined that the relevant information has not been supplied to the print data (NO in step S2415), the processing exits the flowchart.

In step S2416, the application 414 notifies the job management unit 412 that the information about the job control information settings 2304 is supplied to the print data. Then, the job management unit 412 registers the information about the job control information settings 2304 in bibliographic information designated in the job management table 500, and the processing exits the flowchart.

The above-described processing enables the multifunction peripheral 103 to utilize, in reservation printing of the print data entered from the PC 102, the owner information, the print permission information, and the information about the job control information settings 2304 registered together with the print data.

### (Print Processing Procedure)

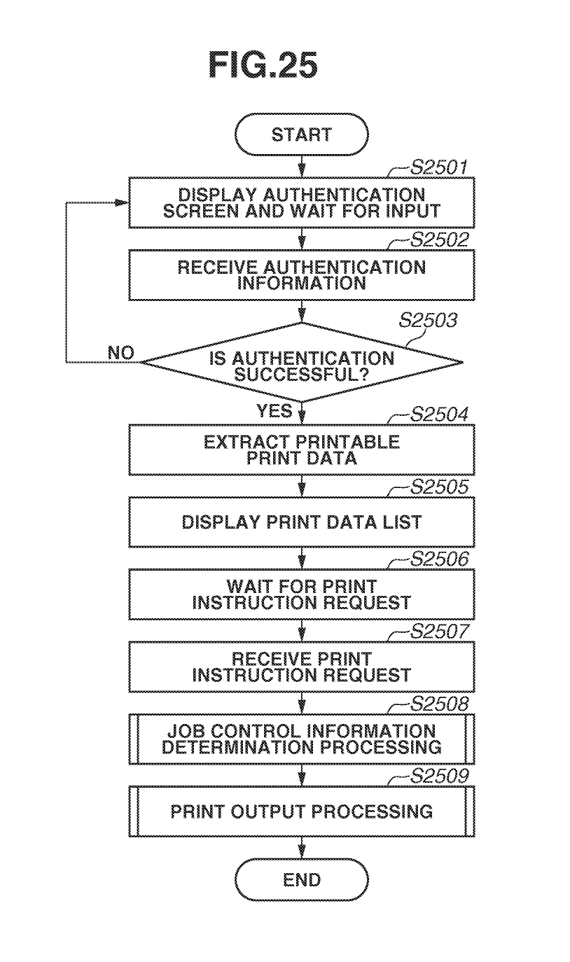

FIG. 25 is a flowchart illustrating example print processing performed by the multifunction peripheral 103 according to the present exemplary embodiment.

The processing in steps S2501 to S2507 is similar to the processing in steps S1101 to S1107 illustrated in FIG. 11, and redundant descriptions thereof will be omitted.

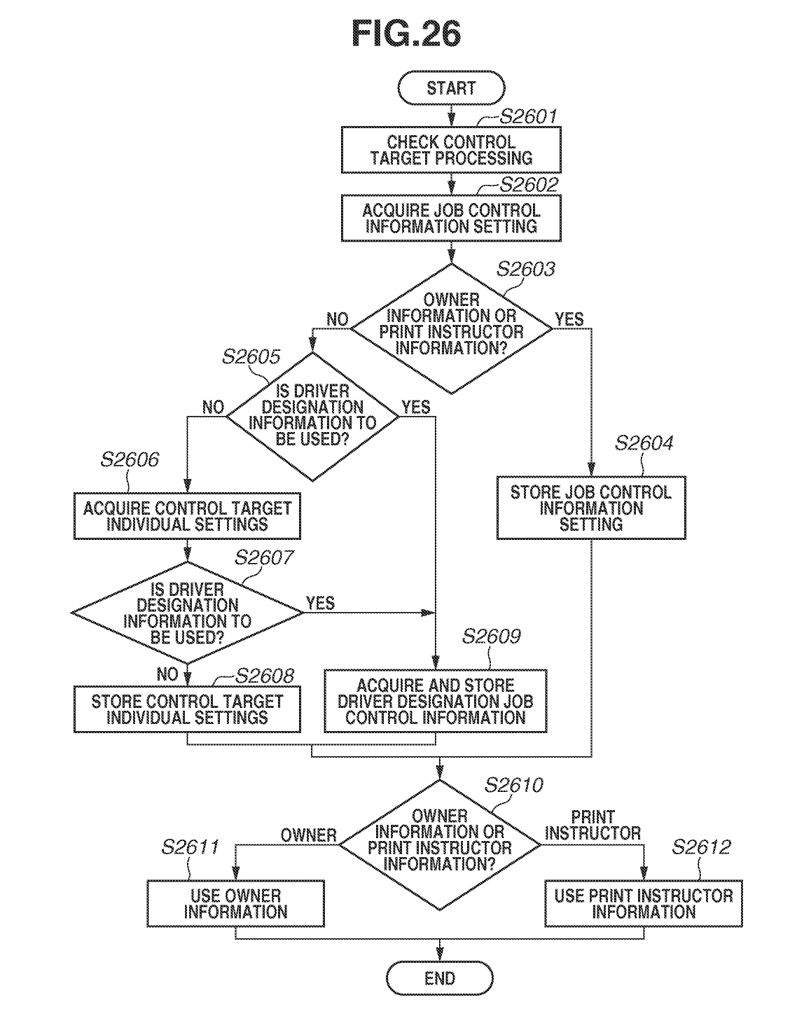

In step S2508, the application 414 performs the job control information determination processing. The processing in step S2508 will be described in detail below with reference to FIG. 26.

The processing in step S2509 is similar to the processing in step S1112 illustrated in FIG. 11, and redundant description thereof will be omitted. The above-described processing enables the multifunction peripheral 103 to perform print control of the print data entered by using the job control information.

### (Job Control Information Determination Processing Procedure)

FIG. 26 is a flowchart illustrating example job control information determination processing performed by the multifunction peripheral 103 according to the present exemplary embodiment.

In step S2601, the application 414 checks the control target processing which is to be determined.

In step S2602, the application 414 acquires the information about the job control information settings 2109 stored in the HDD 304 via the file system 403.

In step S2603, the application 414 determines whether, in the job control information settings 2109 indicated by the information acquired in step S2602, either “USE OWNER INFORMATION” 2103 or “USE PRINT INSTRUCTOR INFORMATION” 2104 is selected. When either “USE OWNER INFORMATION” 2103 or “USE PRINT INSTRUCTOR INFORMATION” 2104 is determined to be selected (YES in step S2603), the processing proceeds to step S2604. On the other hand, when neither “USE OWNER INFORMATION” 2103 nor “USE PRINT INSTRUCTOR INFORMATION” 2104 is determined to be selected (NO in step S2603), the processing proceeds to step S2605.

In step S2604, the application 414 stores information about setting values of the job control information settings 2109.

In step S2605, the application 414 determines whether, in the job control information settings 2109 indicated by the information acquired in step S2602, “USE DRIVER DESIGNATION INFORMATION” 2102 is selected. When “USE DRIVER DESIGNATION INFORMATION” 2102 is determined to be selected (YES in step S2605), the processing proceeds to step S2609. On the other hand, when “USE DRIVER DESIGNATION INFORMATION” 2102 is determined to be not selected (NO in step S2605), the processing proceeds to step S2606.

In step S2606, the application 414 acquires information about “INDIVIDUAL SETTINGS” in the job control information settings 2109.

In step S2607, the application 414 determines whether, in the individual settings indicated by the information acquired in step S2606, “USE DRIVER DESIGNATION INFORMATION” is selected. When “USE DRIVER DESIGNATION INFORMATION” is determined to be selected (YES in step S2607), the processing proceeds to step S2609. On the other hand, when “USE DRIVER DESIGNATION INFORMATION” is determined to be not selected (NO in step S2607), the processing proceeds to step S2608.

In step S2608, the application 414 stores the information about the setting values of control target individual settings.

In step S2609, the application 414 acquires from the job management unit 412 the information about the job control information settings 2304 designated by the driver, which is registered in the job management table 500, and stores the information.

In step S2610, the application 414 determines which of “USE OWNER INFORMATION” and “USE PRINT INSTRUCTOR INFORMATION” is the setting value indicated by the information stored in step S2609. When the relevant setting value is determined to be “USE OWNER INFORMATION” (OWNER in step S2610), the processing proceeds to step S2611. On the other hand, when the relevant setting value is determined to be “USE PRINT INSTRUCTOR INFORMATION” (PRINT INSTRUCTOR in step S2610), the processing proceeds to step S2612.

In step S2611, the application 414 determines that the owner information is to be used for job control, and the processing exits the flowchart illustrated in FIG. 26.

In step S2612, the application 414 determines that the print instructor information is to be used for job control, and the processing exits the flowchart illustrated in FIG. 26.

When the application 414 confirms that there is a plurality of control targets for determining the job control information in step S2601, the application 414 repeats the processing in steps S2606 to S2612 for the number of control targets.

The above-described processing enables the multifunction peripheral 103 to perform print control by using the settings as intended by the administrator and the user of the multifunction peripheral 103, based on the information indicating the job control information settings 2109 and the information indicating the job control information settings 2304.

As described above, according to the present exemplary embodiment, the administrator and the user of the multifunction peripheral 103 can collectively set either the owner information or the print instructor information to be used for job control by using the job control information settings 2109 set via the operation unit 306. Further, when the above-described administrator sets “USE DRIVER DESIGNATION INFORMATION” in the job control information settings 2109, the multifunction peripheral 103 can perform print control by using the information designated by the printer driver of the PC 102. More specifically, the multifunction peripheral 103 can perform print control by using either the owner information or the print instructor information designated by the printer driver. Thus, the multifunction peripheral 103 can perform print control by using the settings as intended by the administrator, based on the information about the job control information settings 2109 and the information about the job control information settings 2304.

According to the above-described exemplary embodiments, in a case where the print data supplier differs from the print instruction requester, the multifunction peripheral 103 can determine whether the print instruction requester is a substitutional printer, and perform print control based on suitable information. Specifically, it is possible to provide a technique for controlling a print job based on suitable user information.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-174826 filed Aug. 26, 2013, which is hereby incorporated by reference herein in its entirety.

What is claimed is:

1. An image forming apparatus comprising:
a receiver configured to receive data which owner information is attached to, the owner information indicating an owner of the data;
a storage device configured to store the data;
an input device configured to receive an input of a print instruction from a login user; and
a print control unit configured to execute a print process of the data in accordance with the print instruction,
wherein the print control unit is configured to determine whether to use authority of the login user or the owner of the data in a case where the login user does not correspond to the owner of the data.

2. The image forming apparatus according to claim 1, wherein the print control unit performs the determination based on print permission information attached to the data.

3. The image forming apparatus according to claim 2, wherein, in a case where a print permission target of the data indicated by the print permission information includes the login user, the print control unit determines that the authority of the login user is to be used.

4. The image forming apparatus according to claim 2, wherein, in a case where a print permission target of the data indicated by the print permission information includes information of the login user, and where the number of print permission targets is smaller than a predetermined number, the print control unit determines that the authority of the owner of the data is to be used.

5. The image forming apparatus according to claim 1, wherein the print control unit performs the determination based on a predetermined determination condition.

6. The image forming apparatus according to claim 5, wherein, the print control unit performs the determination based on a combination of the owner and the login user.

7. The image forming apparatus according to claim 1, wherein the determination unit performs the determination based on a job name attached to the data.

8. The image forming apparatus according to claim 1, further comprising:
a display unit configured to display an input screen for inputting settings related to printing of the data,
wherein the print control unit performs the determination based on first control information indicating the settings input via the input screen displayed in the display unit.

9. The image forming apparatus according to claim 8, wherein the print control unit performs the determination based on the first control information, and second control information indicating the settings related to printing of the data appended to the data.

10. The image forming apparatus according to claim 1, further comprising:
an updating unit configured to update counter information of a user corresponding to the authority which has been determined to be used.

11. The image forming apparatus according to claim 1, further comprising:
a log recording unit configured to record a log based on user information of a user corresponding to the authority information which has been determined to be used.

12. An image forming method comprising:
receiving data which owner information is attached to, the owner information indicating an owner of the data;
storing the received data;
receiving an input of a print instruction from a login user;
in response to the print instruction, determining whether to use authority of the login user or the owner of the data in a case where the login user does not correspond to the owner of the data; and
executing a print process of the data based on the determination.

13. A non-transitory storage medium storing a program for causing a computer to execute a method comprising:
receiving data which owner information is attached to, the owner information indicating an owner of the data;
storing the received data;
receiving an input of a print instruction from a login user;
in response to the print instruction, determining whether to use authority of the login user or the owner of the data in a case where the login user does not correspond to the owner of the data; and
executing a print process of the data based on the determination.
